(19) United States
(12) Patent Application Publication
(10) Pub. No.: US 2018/0164110 A1
(43) Pub. Date: Jun. 14, 2018

(54) RANKING SYSTEM, SERVER, RANKING METHOD, RANKING PROGRAM, RECORDING MEDIUM, AND ELECTRONIC APPARATUS

(71) Applicant: SEIKO EPSON CORPORATION, Tokyo (JP)

(72) Inventors: Tsubasa SHIRAI, Shiojiri-shi (JP); Toshiyuki MISAWA, Matsumoto-shi (JP)

(73) Assignee: SEIKO EPSON CORPORATION, Tokyo (JP)

(21) Appl. No.: 15/824,591

(22) Filed: Nov. 28, 2017

(30) Foreign Application Priority Data
Dec. 14, 2016 (JP) 2016-242027

(51) Int. Cl. G01C 21/34; G01C 21/36

(52) U.S. Cl. CPC G01C 21/3484; G01C 21/3697; G01C 21/3461

(57) ABSTRACT

A ranking system includes a selection section that selects a reference for ranking a plurality of routes, a ranking section that ranks the plurality of routes based on the selected reference, and an output section that outputs a result of the ranking or the ranked routes.

### CROSS-REFERENCE TO RELATED APPLICATIONS

This application claims the benefit of Japanese Patent Application No. 2016-242027, filed on Dec. 14, 2016, the entire disclosure of which is hereby incorporated herein by reference in its entirety.

### BACKGROUND

### 1. Technical Field

The present invention relates to a ranking system, a server, a ranking method, a ranking program, a recording medium, and an electronic apparatus.

### 2. Related Art

JP-A-2015-210116 discloses a GPS (global positioning system) device that provides a user with information that affects a period required for the user to travel along a predetermined route on the basis of travel histories of other persons. The user can estimate the degree of difficulty of the route on the basis of the provided information.

However, the information with which the GPS device provides the user is directed to a specific route and is therefore not always effective in a case where the user objectively desires to evaluate whether or not the route is more difficult than other routes.

### SUMMARY

An advantage of some aspects of the invention is to provide a ranking system, a server, a ranking method, a ranking program, a recording medium, and an electronic apparatus capable of producing information that is effective when a user compares a plurality of routes different from one another with one another.

The invention can be implemented as the following aspects or application examples.

### APPLICATION EXAMPLE 1

A ranking system according to this application example includes a selection section that selects a reference for ranking a plurality of routes, a ranking section that ranks the plurality of routes based on the selected reference, and an output section that outputs a result of the ranking.

Since a result of the ranking is not based on a user's personal point of view but is based on a selected reference, the result is effective information for objectively comparing the plurality of routes with one another. Further, since a result of the ranking varies depending on the selection of a reference, the user can, for example, acquire a result of the ranking by using the user's desired reference or acquire different results of the ranking by using a variety of references.

### APPLICATION EXAMPLE 2

In the ranking system according to the application example, the reference may be formed of a plurality of references different from one another, and the ranking section may perform the ranking by weighting each of the plurality of references.

Therefore, for example, in a case where a first reference and a second reference relating a route are used as the plurality of references, ranking primarily using the first reference and ranking primarily using the second reference can be performed. Further, ranking in which the allocation ratio between the importance of the first reference and the importance of the second reference is set at a predetermined allocation ratio can also be performed.

### APPLICATION EXAMPLE 3

In the ranking system according to the application example, the weighting may be specified by a user.

The user can therefore set the allocation ratio between the importance of the first reference and the importance of the second reference at the user's preferred allocation ratio.

### APPLICATION EXAMPLE 4

In the ranking system according to the application example, the output section may present the plurality of routes in a descending order of the ranks.

The user can therefore recognize the ranks of the routes in the presented order.

### APPLICATION EXAMPLE 5

In the ranking system according to the application example, the output section may display the plurality of ranked routes along with the ranks of the routes on a map.

The user can therefore intuitively grasp the correspondence between the positions of the routes and the ranks thereof on the map.

### APPLICATION EXAMPLE 6

A server according to this application example includes a selection section that selects a reference for ranking a plurality of routes, a ranking section that ranks the plurality of routes based on the selected reference, and an output section that outputs a result of the ranking or the ranked routes.

Since a result of the ranking is not based on a user's personal point of view but is based on a selected reference, the result is effective information for objectively comparing the plurality of routes with one another. Further, since a result of the ranking varies depending on the selection of a reference, the user can, for example, acquire a result of the ranking by using the user's desired reference or acquire different results of the ranking by using a variety of references.

### APPLICATION EXAMPLE 7

A ranking method according to this application example includes selecting a reference for ranking a plurality of routes, ranking the plurality of routes based on the selected reference, and outputting a result of the ranking or the ranked routes.

Since a result of the ranking is not based on a user's personal point of view but is based on a selected reference, the result is effective information for objectively comparing the plurality of routes with one another. Further, since a result of the ranking varies depending on the selection of a reference, the user can, for example, acquire a result of the ranking by using the user's desired reference or acquire different results of the ranking by using a variety of references.

### APPLICATION EXAMPLE 8

In the ranking method according to the application example, the reference may be formed of a plurality of references different from one another, and the ranking may be performed by weighting each of the plurality of references.

Therefore, for example, in a case where a first reference and a second reference relating a route are used as the plurality of references, ranking primarily using the first reference and ranking primarily using the second reference can be performed. Further, ranking in which the allocation ratio between the importance of the first reference and the importance of the second reference is set at a predetermined allocation ratio can also be performed.

### APPLICATION EXAMPLE 9

In the ranking method according to the application example, the weighting may be specified by a user.

The user can therefore set the allocation ratio between the importance of the first reference and the importance of the second reference at the user's preferred allocation ratio.

### APPLICATION EXAMPLE 10

In the ranking method according to the application example, in the outputting, the plurality of routes may be presented in a descending order of the ranks.

The user can therefore recognize the ranks of the routes in the presented order.

### APPLICATION EXAMPLE 11

In the ranking method according to the application example, in the outputting, the plurality of ranked routes may be displayed along with the ranks of the routes on a map.

The user can therefore intuitively grasp the correspondence between the positions of the routes and the ranks thereof on the map.

### APPLICATION EXAMPLE 12

A ranking program according to this application example causes a computer to execute selecting a reference for ranking a plurality of routes, ranking the plurality of routes based on the selected reference, and outputting a result of the ranking or the ranked routes.

Since a result of the ranking is not based on a user's personal point of view but is based on a selected reference, the result is effective information for objectively comparing the plurality of routes with one another. Further, since a result of the ranking varies depending on the selection of a reference, the user can, for example, acquire a result of the ranking by using the user's desired reference or acquire different results of the ranking by using a variety of references.

### APPLICATION EXAMPLE 13

A recording medium that records the ranking program according to this application example causes a computer to execute selecting a reference for ranking a plurality of routes, ranking the plurality of routes based on the selected reference, and outputting a result of the ranking or the ranked routes.

Since a result of the ranking is not based on a user's personal point of view but is based on a selected reference, the result is effective information for objectively comparing the plurality of routes with one another. Further, since a result of the ranking varies depending on the selection of a reference, the user can, for example, acquire a result of the ranking by using the user's desired reference or acquire different results of the ranking by using a variety of references.

### APPLICATION EXAMPLE 14

An electronic apparatus according to this application example selects a reference for ranking a plurality of routes, ranks the plurality of routes based on the selected reference, and outputs a result of the ranking or the ranked routes.

Since a result of the ranking is not based on a user's personal point of view but is based on a selected reference, the result is effective information for objectively comparing the plurality of routes with one another. Further, since a result of the ranking varies depending on the selection of a reference, the user can, for example, acquire a result of the ranking by using the user's desired reference or acquire different results of the ranking by using a variety of references.

### APPLICATION EXAMPLE 15

In the electronic apparatus according to the application example, the reference may be formed of a plurality of references different from one another, and the ranking may be performed by weighting each of the plurality of references.

Therefore, for example, in a case where a first reference and a second reference relating a route are used as the plurality of references, ranking primarily using the first reference and ranking primarily using the second reference can be performed. Further, ranking in which the allocation ratio between the importance of the first reference and the importance of the second reference is set at a predetermined allocation ratio can also be performed.

### APPLICATION EXAMPLE 16

In the electronic apparatus according to the application example, the weighting may be specified by a user.

The user can therefore set the allocation ratio between the importance of the first reference and the importance of the second reference at the user's preferred allocation ratio.

### APPLICATION EXAMPLE 17

In the electronic apparatus according to the application example, the outputting may include presenting the plurality of routes in a descending order of the ranks.

The user can therefore recognize the ranks of the routes in the presented order.

### APPLICATION EXAMPLE 18

In the electronic apparatus according to the application example, the outputting may include displaying the plurality of ranked routes along with the ranks of the routes on a map.

The user can therefore intuitively grasp the correspondence between the positions of the routes and the ranks thereof on the map.

### BRIEF DESCRIPTION OF THE DRAWINGS

The invention will be described with reference to the accompanying drawings, wherein like numbers reference like elements.

FIG. 1 shows an example of a diagram for describing the configuration of a system in an embodiment.

FIG. 2 shows an example of the functional block diagram of an electronic apparatus.

FIG. 3 is an example of the functional block diagram of an information terminal, a main server, and a weather server.

FIG. 4 shows an example of a screen on which ranking is displayed.

FIG. 5 shows an example of an initial display screen provided by an application program.

FIG. 6 shows an example of a ranking analysis setting screen.

FIG. 7 shows an example of indices relating to exertion.

FIG. 8 shows an example of a screen for inputting and managing a blend of indices relating to the exertion.

FIG. 9 shows examples of a restriction condition.

FIG. 10 shows an example of a screen for setting the restriction condition.

FIGS. 11A and 11B show an example of a screen on which the ranking is displayed.

FIG. 12 shows an example of a screen on which a map is displayed.

FIG. 13 shows an example of a screen with a registered mountain selected.

FIG. 14 shows an example of data on exertion on a mountain (route) basis.

FIG. 15 shows an example of the procedure of principal component analysis.

FIG. 16 shows an example of normalized data.

FIG. 17 is an example of data on dot products on a mountain (route) basis.

FIG. 18 shows an example of data on the dot products in a case where only positive portions are employed.

FIG. 19 shows a result of inverse specification.

FIG. 20 shows an example of the initial display screen provided by the application program.

FIG. 21 shows an example of a screen on which a mountain climbing plan list is displayed.

FIG. 22 shows an example of a screen for registering a mountain climbing plan.

FIG. 23 shows an example of a screen on which a calendar is displayed.

FIG. 24 shows an example of a screen for carrying out an end process.

FIG. 25 shows an example of a screen on which a data list is displayed.

FIG. 26 shows an example of a screen on which registered data are displayed.

FIG. 27 shows an example of a screen for editing traveling companions.

FIG. 28 shows an example of a screen for setting a restriction condition under which weather analysis is performed.

FIG. 29 shows an example of a screen on which a graph of the chance of rain is displayed.

FIG. 30 shows an example of a table of the chance of rain on a combination basis.

FIG. 31 shows an example of a screen on which the chance of rain is displayed in the form of a map.

### DESCRIPTION OF EXEMPLARY EMBODIMENTS

A preferable embodiment of the invention will be described below in detail with reference to the drawings. It is not intended that the embodiment described below unduly limits the contents of the invention set forth in the appended claims. Further, all configurations described below are not necessarily essential configuration requirements of the invention.

### 1. Server System

### 1-1. Configuration of Server System

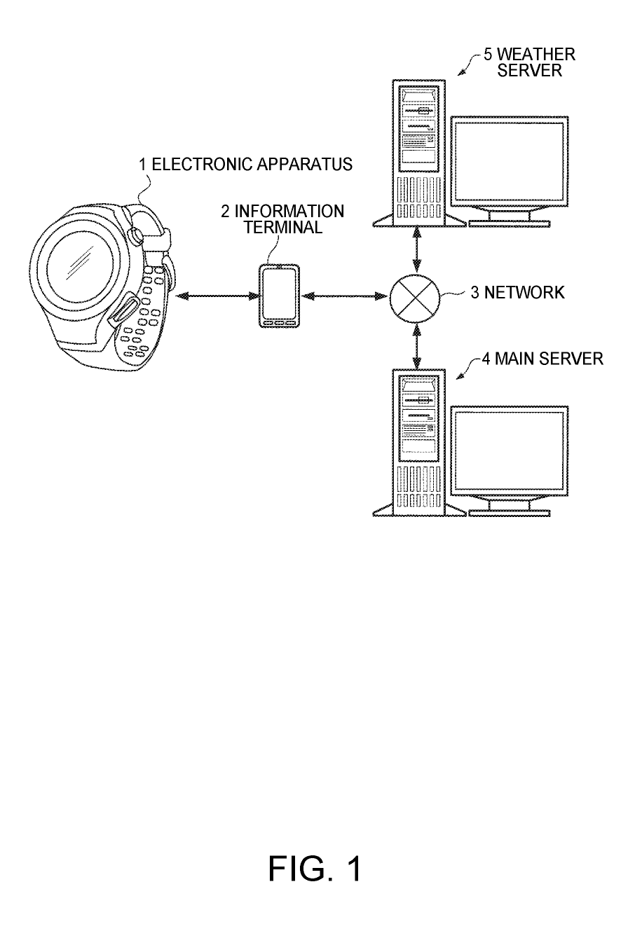

FIG. 1 shows an example a diagram for describing the configuration of a system in the embodiment. A server system (example of ranking system) includes an electronic apparatus 1, an information terminal 2, a main server 4, and a weather server 5, as shown in FIG. 1. The information terminal 2, the main server 4, and the weather server 5 can be connected to each other via a network 3, such as the Internet, and the information terminal 2, the main server 4, and the weather server 5 can communicate with each other over the network 3. The electronic apparatus 1 can communicate with the information terminal 2, for example, over short-range wireless communication.

The electronic apparatus 1 is a portable information apparatus worn on part of a user's body in an outdoor scene, for example, mountain climbing and trekking. The “mountain climbing” used herein includes general outdoor travel, such as traveling along a maintained route with the aim of reaching a peak, traveling along a non-maintained route with the aim of reaching a peak, rock climbing, climbing a mountain covered with snow, trekking, traveling along a flat route (hiking), jogging, walking, and training. The electronic apparatus 1 is worn, for example, in any position on the site extending from the user's elbow to the user's hand (forearm) so that the electronic apparatus 1 can acquire measured data on the user's body in a contact or noncontact manner and the user can look at the electronic apparatus 1 whenever necessary. In the example shown in FIG. 1, the electronic apparatus 1 is configured as a wrist-type (wristwatch-shaped) electronic apparatus (outdoor watch), and the electronic apparatus 1 is worn on a wrist.

The information terminal 2 is an information terminal used by the user who uses the electronic apparatus 1 and is formed, for example, of a smartphone, a portable or desktop PC (personal computer), a tablet PC, or other computing device.

The main server 4 is a server (sometimes also referred to as a server computer or a server computing device) that provides the user who uses the electronic apparatus 1 with information relating to the use of the electronic apparatus and manages measured data acquired by the electronic apparatus 1 on a user basis.

The weather server 5 is a server that provides the user who uses the main server 4 and the electronic apparatus 1 with information on the weather at each location. In the present embodiment, the description will be primarily made of a case where the information is not provided to the user directly from the weather server 5 but is provided via the main server 4.

### 1-2. Configuration of Electronic Apparatus

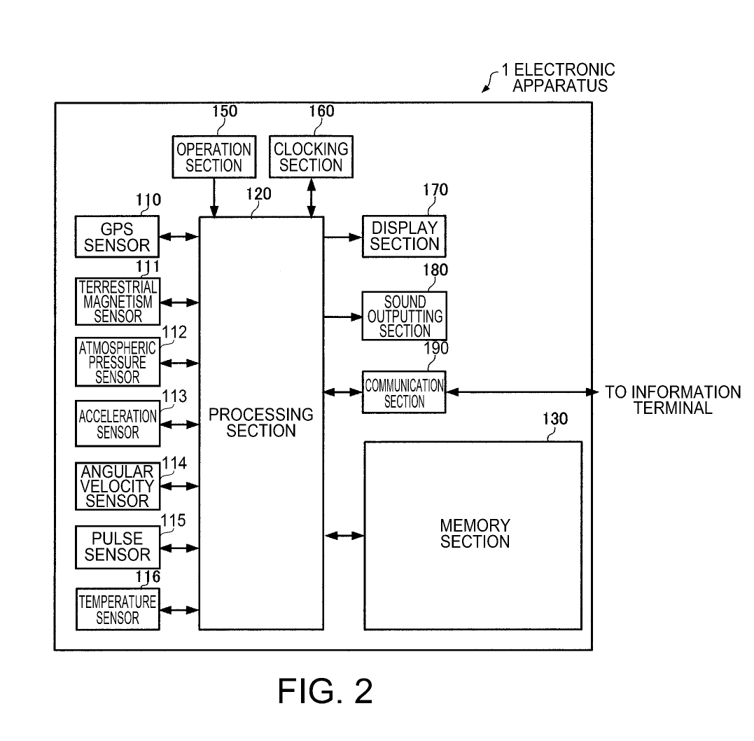

FIG. 2 shows an example of the functional block diagram of the electronic apparatus 1.

The electronic apparatus 1 is formed of a GPS sensor 110, a terrestrial magnetism sensor 111, an atmospheric pressure sensor 112, an acceleration sensor 113, an angular velocity sensor 114, a pulse sensor 115, a temperature sensor 116, a processing section 120, a memory section 130, an operation section 150, a clocking section 160, a display section 170, a sound outputting section 180, a communication section 190, and other components, as shown in FIG. 2. In the configuration of the electronic apparatus 1, however, part of the components described above may be omitted or changed, or another component (humidity sensor, ultraviolet ray sensor, for example) may be added.

The GPS sensor 110 is a sensor that produces positioning data (latitude, longitude, altitude, velocity vector, and other pieces of data) representing the position and other factors of the electronic apparatus 1 and outputs the positioning data to the processing section 120, and the GPS sensor 110 is formed, for example, of a GPS receiver (GPS: global positioning system). The GPS sensor 110 receives an externally incoming electromagnetic wave containing a satellite signal that belongs to a predetermined frequency band via a GPS antenna that is not shown, extracts GPS signals from GPS satellites, and produces the positioning data representing the position and other factors of the electronic apparatus 1 on the basis of the GPS signals.

The terrestrial magnetism sensor 111 is a sensor that detects a terrestrial magnetism vector showing the direction of the geomagnetic field viewed from the electronic apparatus 1, and the terrestrial magnetism sensor 111 produces, for example, terrestrial magnetism data representing the magnetic flux densities in three axial directions perpendicular to one another. For example, an MR (magnet resistive) element, an MI (magnet impedance) element, or a Hall element is used as the terrestrial magnetism sensor 111.

The atmospheric pressure sensor 112 is a sensor that detects the surrounding atmospheric pressure (barometric pressure) and has, for example, a pressure sensitive element operating on the basis of a method using a change in the resonance frequency of a vibrating piece (vibration method). The pressure sensitive element is a piezoelectric vibrator made, for example, of quartz, lithium niobate, lithium tantalate, or any other piezoelectric material and is, for example, a tuning-fork-type vibrator, a dual-tuning-fork-type vibrator, an AT vibrator (thickness shear vibrator), or an SAW resonator. The atmospheric pressure sensor 112 may, for example, be a MEMS-type atmospheric pressure sensor manufactured by using a semiconductor manufacturing technology. Specifically, the atmospheric pressure sensor 112 includes a diaphragm section that undergoes bending deformation under pressure and a distortion detecting element that detects the bending of the diaphragm section. The diaphragm section is made, for example, of silicon. The distortion detecting element is, for example, a piezoresistor. The output from the atmospheric pressure sensor 112 may be used to correct the positioning data.

The acceleration sensor 113 is an inertia sensor that detects acceleration in each of three axial directions that intersect one another (ideally perpendicular to one another) and outputs a digital signal according to the magnitude and direction of the detected acceleration in each of the three axes (acceleration data). The output from the acceleration sensor 113 may be used to correct the positional information contained in the positioning data from the GPS sensor.

The angular velocity sensor 114 is an inertia sensor that detects angular velocity in each of three axial directions that intersect one another (ideally perpendicular to one another) and outputs a digital signal according to the magnitude and direction of the measured angular velocity in each of the three axes (angular velocity data). The output from the angular velocity sensor 114 may be used to correct the positional information contained in the positioning data from the GPS sensor.

The pulse sensor 115 is a sensor that produces a signal representing the user's pulse (heart rate) and outputs the signal to the processing section 120. The pulse sensor 115 includes, for example, an LED light source or any other light source that emits measurement light having an appropriate wavelength toward a subcutaneous blood vessel and a light receiving element that detects a change in the intensity of light produced at the blood vessel in response to the measurement light.

The temperature sensor 116 is a temperature sensitive element that outputs a signal according to the surrounding temperature (voltage according to temperature, for example). The temperature sensor 116 may instead be a sensor that outputs a digital signal according to the temperature. The temperature sensor 116 has, for example, a pressure sensitive element operating on the basis of a method using a change in the resonance frequency of a vibrating piece according to the surrounding temperature (vibration method). The pressure sensitive element is a piezoelectric vibrator made, for example, of quartz, lithium niobate, lithium tantalate, or any other piezoelectric material and is, for example, a tuning-fork-type vibrator, a dual-tuning-fork-type vibrator, an AT vibrator (thickness shear vibrator), or an SAW resonator. The temperature sensor 116 may instead be formed of a temperature sensitive element that detects the temperature with a thermocouple or a thermistor.

The memory section 130 is formed, for example, of one or more IC memories and has a ROM that stores data, such as programs, and a RAM that serves as a work region used by the processing section 120. The RAM also includes a nonvolatile RAM.

The operation section 150 is formed, for example, of buttons, keys, a microphone, a touch panel, a voice recognition function (using microphone that is not shown), and an action detection function (using acceleration sensor 113 or any other component), converts an instruction from the user into an appropriate signal, and transmits the signal to the processing section 120.

The clocking section 160 is formed, for example, of a real-time clock (RTC) IC, produces time data, such as the year, month, day, hour, minute, and second, and transmits the time data to the processing section 120.

The display section 170 is formed, for example, of an LCD (liquid crystal display), an organic EL (electroluminescence) display, an EPD (electrophoretic display), or a tough-panel-type display and displays a variety of images in accordance with an instruction from the processing section 120.

The sound output section 180 is formed, for example, of a loudspeaker, a buzzer, or a vibrator and produces a variety of types of sound (or vibration) in accordance with an instruction from the processing section 120.

The communication section 190 performs a variety of types of control for establishing data communication between the electronic apparatus 1 and the information terminal 2 (such as smartphone). The communication section 190 includes a transceiver that complies, for example, with Bluetooth (registered trademark) (including BTLE: Bluetooth Low Energy), Wi-Fi (registered trademark) (Wi-Fi: Wireless Fidelity), Zigbee (registered trademark), NFC (Near Field Communication), ANT+ (registered trademark), or any other short-range wireless communication standard.

The processing section 120 is formed, for example, of an MPU (micro processing unit), a DSP (digital signal processor), and an ASIC (application specific integrated circuit). The processing section 120 carries out a variety of processes in accordance with programs stored in the memory section 130 and a variety of commands inputted by the user via the operation section 150. The processes carried out by the processing section 120 include data processing in which data produced by the GPS sensor 110, the terrestrial magnetism sensor 111, the atmospheric pressure sensor 112, the acceleration sensor 113, the angular velocity sensor 114, the pulse sensor 115, the temperature sensor 116, the clocking section 160, and other components are processed, display processing in which the display section 170 is caused to display an image, sound output processing in which the sound outputting section 180 is caused to output sound, and other types of processing. The processing section 120 further carries out the process of receiving a control command from the information terminal 2 via the communication section 190 and a variety of types of calculation performed on data received from the information terminal 2 via the communication section 190 in accordance with a variety of programs. The processing section 120 further carries out the process of reading data from the memory section 130 and transmitting the data in a predetermined format to the information terminal 2 via the communication section 190 in accordance with a variety of programs. The processing section 120 further carries out, for example, the process of transmitting a variety of pieces of information to the information terminal 2 via the communication section 190 and displaying a variety of screens on the basis of information received from the information terminal 2 in accordance with a variety of programs. The processing section 120 further carries out a variety of other control processes. For example, the processing section 120 carries out the process of causing the display section 170 to display an image (such as still images, motion images, letters, and symbols) on the basis of at least part of information received via the communication section 190 and information stored in the memory section 130. The electronic apparatus 1 may be provided with a vibration mechanism, and the vibration mechanism may convert a variety of pieces of information into vibration information and notify the user of the vibration information.

### 1-3. Configuration of Information Terminal

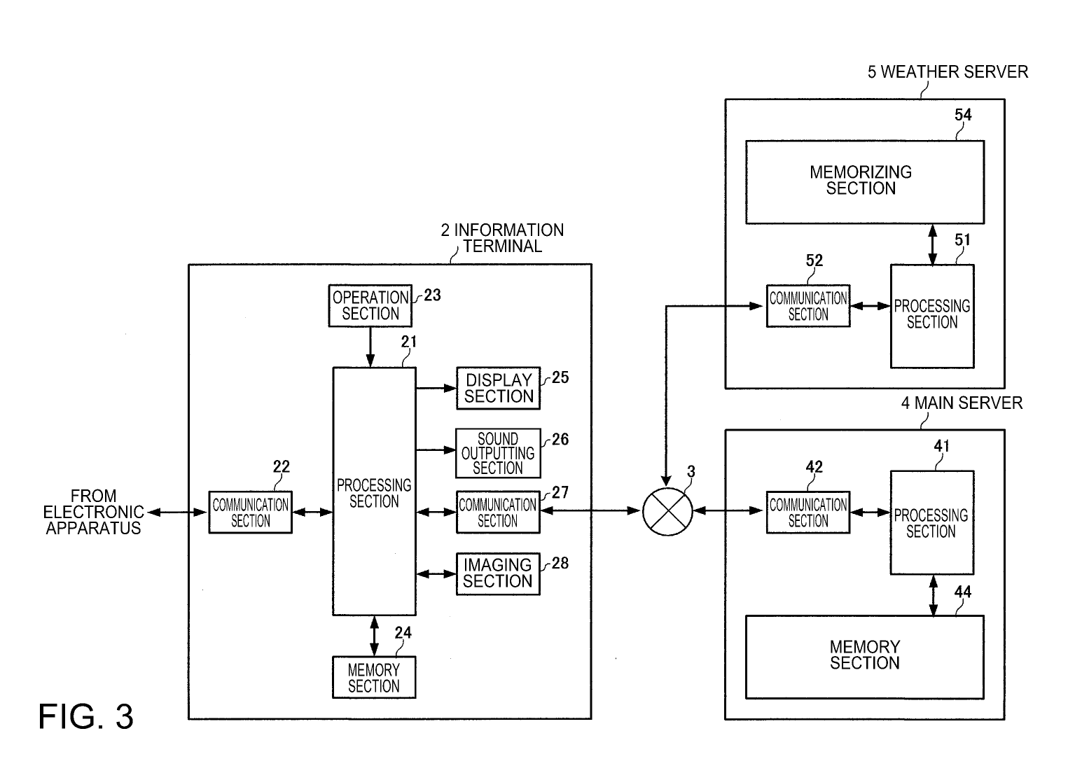

The left portion of FIG. 3 in the plane of view thereof shows an example of the functional block diagram of the information terminal 2. The information terminal 2 is formed of a processing section 21, a communication section 22, an operation section 23, a memory section 24, a display section 25, a sound outputting section 26, a communication section 27, and an imaging section 28, as shown in FIG. 3. In the information terminal 2, however, part of the components described above maybe omitted or changed or another component may be added as appropriate.

The communication section 22 carries out the process of receiving data (measured data) and other pieces of information transmitted in a predetermined format from the electronic apparatus 1 and transmitting the data to the processing section 21, the process of transmitting a control command from the processing section 21 to the electronic apparatus 1, and other processes.

The operation section 23 carries out the process of acquiring data according to the user's operation and transmitting the data to the processing section 21. The operation section 23 may, for example, be a touch panel display, buttons, keys, or a microphone.

The memory section 24 is formed, for example, of a ROM (read only memory), a flash ROM, a RAM (random access memory), or any of a variety of other IC memories (IC: integrated circuit) or a hard disk drive, a memory card, or any other recording medium. The memory section 24 stores a program that allows the processing section 21 to carry out a variety of calculation processes and control processes and a variety of programs, data, and other pieces of information for achieving application functions. The memory section 24 further serves as a work region used by the processing section 21 and temporarily memorizes data acquired via the operation section 23, results of computation performed by the processing section 21 in accordance with a variety of programs, and other pieces of information. The memory section 24 may further memorize data required to be saved for a long period among data produced in the processes carried out by the processing section 21.

The display section 25 displays a result of a process carried out by the processing section 21 in the form of letters, a graph, a table, an animation, or any other image. The display section 25 may, for example, be a CRT (cathode ray tube) , an LCD (liquid crystal display) , a touch panel display, or a head mounted display (HMD) . The functions of the operation section 23 and the display section 25 may be achieved by a single touch panel display.

The sound output section 26 outputs a result of a process carried out by the processing section 21 in the form of voice, buzzer sound, or any other type of sound. The sound output section 26 may, for example, be a loudspeaker or a buzzer.

The communication section 27 performs data communication with a communication section 42 of the main server 4 over the network 3. For example, the communication section 27 carries out the process of receiving data from the processing section 21 and transmitting the data in a predetermined format to the communication section 42 of the main server 4. Further, for example, the communication section 27 carries out the process of receiving information necessary for display of a screen via the communication section of the main server 4 and transmitting the information to the processing section 21 and the process of receiving a variety of types of information from the processing section 21 and transmitting the information to the communication section of the main server 4.

The imaging section 28 is a camera including a lens, a color imaging device, a focus adjusting mechanism, and other components, and the imaging device converts an optical viewing field image formed by the lens into an electric image. Data on the electric image acquired by the imaging device (image data) is transmitted to the processing section 21, saved in the memory section 24, and displayed on the display section 25.

The processing section 21 is formed, for example, of a CPU (central processing unit), a DSP (digital signal processor), and an ASIC (application specific integrated circuit) . The processing section 21 carries out a variety of processes in accordance with programs stored in the memory section 24 and a variety of commands inputted by the user via the operation section 23. The processes carried out by the processing section 21 include data processing in which data produced by the information terminal 2 are processed, display processing in which the display section 25 is caused to display an image, sound output processing in which the sound outputting section 26 is caused to output sound, image processing performed on an image acquired by the imaging section 28, and other types of processing. The processing section 21 may be formed of a single processor or a plurality of processors. The processing section 21 further carries out the process of transmitting a control command to the electronic apparatus 1 via the communication section 22 and a variety of types of calculation performed on data received from the electronic apparatus 1 via the communication section 22 in accordance with a variety of programs. The processing section 21 further carries out the process of reading data from the memory section 24 and transmitting the data in a predetermined format to the main server 4 via the communication section 27 in accordance with a variety of programs. The processing section 120 further carries out, for example, the process of transmitting a variety of pieces of information to the main server 4 via the communication section 27 and displaying a variety of screens on the basis of information received from the main server 4 in accordance with a variety of programs. The processing section 21 further carries out a variety of other control processes. For example, the processing section 21 carries out the process of causing the display section 25 to display an image (such as still images, motion images, letters, and symbols) on the basis of at least part of information received via the communication section 27, information received by the communication section 22, and information stored in the memory section 24. The information terminal 2 or the electronic apparatus 1 may be provided with a vibration mechanism, and the vibration mechanism may convert a variety of pieces of information into vibration information and notify the user of the vibration information.

### 1-4. Configuration of Main Server 4

The lower right portion of FIG. 3 in the plane of view thereof shows an example of the functional block diagram of the main server 4. The main server 4 is formed of a processing section 41 (example of computer or computing device), the communication section 42, and a memory section 44, as shown in the lower right portion of FIG. 3 in the plane of view thereof . In the main server 4, however, part of the components described above may be omitted or changed or another component may be added as appropriate.

The memory section 44 is formed, for example, of a ROM, a flash ROM, a RAM, or any of a variety of other IC memories or a hard disk drive, a memory card, or any other recording medium. The memory section 44 stores a program that allows the processing section 41 to carry out a variety of calculation processes and control processes (example of ranking method) and a variety of programs (example of ranking program) , data, and other pieces of information for achieving application functions. The memory section 44 serves as a work region used by the processing section 41 and temporarily stores results of computation performed by the processing section 41 in accordance with a variety of programs and other pieces of information. The memory section 44 may further memorize data required to be saved for a long period among data produced in the processes carried out by the processing section 41. The variety of information stored in the memory section 44 will be described later.

The communication section 42 performs data communication with the communication section 27 of the information terminal 2 over the network 3. For example, the communication section 42 carries out the process of receiving data via the communication section 27 of the information terminal 2 and transmitting the data to the processing section 41. Further, for example, the communication section 42 carries out the process of transmitting information necessary for display of a screen to the communication section 27 of the information terminal 2 in a predetermined format and the process of receiving information via the communication section of the information terminal 2 and transmitting the information to the processing section 41.

The processing section 41 carries out the process of receiving data from the information terminal 2 via the communication section 42 and causing the memory section 44 to store the data in accordance with a variety of programs. The processing section 41 further carries out, for example, the process of receiving a variety of pieces of information from the information terminal 2 and transmitting information necessary for display of a variety of screens to the information terminal 2 via the communication section 42 in accordance with a variety of programs. The processing section 41 further carries out a variety of other control processes.

### 1-5. Configuration of Weather Server

The upper right portion of FIG. 3 in the plane of view thereof shows an example of the functional block diagram of the weather server 5. The weather server 5 is formed of a processing section 51, a communication section 52, and a memory section 54, as shown in FIG. 3. In the weather server 5, however, part of the components described above may be omitted or changed or another component may be added as appropriate.

The memory section 54 is formed, for example, of a ROM, a flash ROM, a RAM, or any of a variety of other IC memories or a hard disk drive, a memory card, or any other recording medium. The memory section 54 stores a program that allows the processing section 51 to carryout a variety of calculation processes and control processes and a variety of programs, data, and other pieces of information for achieving application functions. The memory section 54 serves as a work region used by the processing section 51 and temporarily stores results of computation performed by the processing section 51 in accordance with a variety of programs and other pieces of information. The memory section 54 may further memorize data required to be saved for a long period among data produced in the processes carried out by the processing section 51. The variety of information stored in the memory section 54 will be described later.

The communication section 52 performs data communication with the communication section 27 of the information terminal 2 over the network 3. For example, the communication section 52 carries out the process of receiving data via the communication section 27 of the information terminal 2 and transmitting the data to the processing section 51. Further, for example, the communication section 52 carries out the process of transmitting information necessary for display of a screen to the communication section 27 of the information terminal 2 in a predetermined format and the process of receiving information via the communication section of the information terminal 2 and transmitting the information to the processing section 51.

The processing section 51 carries out the process of receiving data from the information terminal 2 via the communication section 52 and causing the memory section 54 to memorize the data in accordance with a variety of programs. The processing section 51 further carries out, for example, the process of receiving a variety of pieces of information from the information terminal 2 and transmitting information necessary for display of a variety of screens to the information terminal 2 via the communication section 52 in accordance with a variety of programs. The processing section 51 further carries out a variety of other control processes.

### 1-6. User's Action

The user's action will next be described with reference to FIG. 1.

1-6-1. Registration of mountain climbing plan in main server

The user operates the information terminal 2 to access the main server 4 via the network 3 and creates a mountain climbing plan data file (GPX file, for example) by using information on a map or any other information provided from the main server 4 over the network 3.

The mountain climbing plan data file (file in GPX format, for example) contains (i) the name of the mountain climbing plan (name of plan), (ii) the coordinates of the position of each point that forms a mountain climbing route, (iii) the date and time when the user starts the mountain climbing, (iv) the date and time when the user ends the mountain climbing, (v) the coordinates of the position of the point where the user starts the mountain climbing, (vi) the coordinates of the position of the point where the user ends the mountain climbing, (vii) the coordinates of the position of each representative point (such as peak, rest location) on the route, (viii) the overall length of the mountain climbing route, (ix) the difference in altitude across the mountain climbing route, and other factors. Among the pieces of information described above, the information (ii) is written on the mountain climbing plan data file, and the information (i) , (iii) to (ix) is written as tag information on the mountain climbing plan data file. Data measured by the electronic apparatus 1 during actual mountain climbing are also written on the mountain climbing plan data file. The mountain climbing plan data file containing data on a mountain climbing route is also referred to as “mountain climbing route data” as appropriate.

The user then uploads the created mountain climbing plan data file (file in GPX format, for example) to the main server 4. At this point, the mountain climbing plan data file (file in GPX format, for example) is registered in a database assigned to the user in the memory section 54 of the main server 4. The user can therefore save a plurality of mountain climbing plan data files created by the user in the main server 4. At least one of the mountain climbing plan data files registered in the database can be disclosed to other users. Further, the user can save at least one of mountain climbing plan data files disclosed by other users in the main server 4 as one of the user's mountain climbing plan data files.

The information terminal 2 and the main server 4 carry out known processes of registering a mountain climbing plan data file in the main server 4, and no description of the processes will therefore be made.

It is assumed that an application program required to allow the information terminal 2 and the main server 4 to transmit and receive information to and from each other is installed on the memory section 24 of the information terminal 2 in advance, and that the application program is used to register a mountain climbing plan data file. The application program may instead be written on the memory section 24 from a recording medium that is not shown.

### 1-6-2. Writing Mountain Climbing Plan Data on Electronic Apparatus

The user accesses the main server 4 from the information terminal 2 with the electronic apparatus 1 connected to the information terminal 2 and writes a mountain climbing plan data file added to the main server 4 on the electronic apparatus 1 via the information terminal 2. The mountain climbing plan data file written on the electronic apparatus 1 is used, for example, by a navigation program in a case where the user actually performs mountain climbing in accordance with the mountain climbing plan data. The mountain climbing plan data file is not necessarily written on the electronic apparatus 1, and only data on the mountain climbing route contained in the mountain climbing plan data file may be written in a predetermined format on the electronic apparatus 1.

The electronic apparatus 1 carries out a known process of writing a mountain climbing plan data file on the electronic apparatus 1, and no description of the process will therefore be made.

It is assumed that the application program described above is used to write a mountain climbing plan data file on the electronic apparatus 1.

### 1-6-3. Uploading Measure Data to Main Server

Having performed mountain climbing using the mountain climbing plan data (data on mountain climbing route), the user connects the electronic apparatus 1 to the information terminal 2 and uploads measured data acquired during the mountain climbing with the variety of sensors in the electronic apparatus 1 to the main server 4 via the information terminal 2. The measured data are written on a relevant film (mountain climbing plan data file) in the database in the main server 4. The user can therefore save the data measured by the user during the mountain climbing in the main server 4. The measured data can be used to manage the user's health, improve the user's performance, and otherwise benefit the user.

The information terminal 2 and the main server 4 carry out known processes of writing measure data on the main server 4, and no description of the processes will therefore be made.

It is assumed that the application program described above is used to save measured data in the main server 4.

### 1-7. Data Memorized by System

### 1-7-1. Data Stored in Memory Section of Electronic Apparatus

The memory section 130 of the electronic apparatus 1 stores, for example, the following data.

### (1) Programs

The programs memorized in the memory section 130 of the electronic apparatus 1 are programs executed by the processing section 120 of the electronic apparatus 1. The programs include a measurement program that drives at least one of the sensors incorporated in the electronic apparatus (GPS sensor 110, terrestrial magnetism sensor 111, atmospheric pressure sensor 112, acceleration sensor 113, angular velocity sensor 114, pulse sensor 115, and temperature sensor 116) and creates measured data on the basis of outputs from the sensors (sensed data). The programs may include a navigation program that guides the user as intended by a mountain climbing plan on the basis of mountain climbing data saved in the memory section 130 of the electronic apparatus 1.

### (2) Measured Data

The measured data memorized in the memory section 130 of the electronic apparatus 1 are measured data acquired by at least one of the sensors incorporated in the electronic apparatus 1 (GPS sensor 110, terrestrial magnetism sensor 111, atmospheric pressure sensor 112, acceleration sensor 113, angular velocity sensor 114, pulse sensor 115, and temperature sensor 116) . The measured data are, for example, outputs from the sensors (sensed data) at each point of time with the outputs related to the point of time (time series data).

### (3) Mountain Climbing Plan Data

The mountain climbing plan data memorized in the memory section 130 of the electronic apparatus 1 is a mountain climbing plan data file written by the information terminal 2. A mountain climbing plan data file contains data on at least one mountain climbing route. Data on a mountain climbing route is data on the coordinates of the position of each point that forms the mountain climbing route. The mountain climbing plan data file further contains the name of the plan, the date and time when the user starts the mountain climbing, the date and time when the user ends the mountain climbing, the coordinates of the position of the point where the user starts the mountain climbing, the coordinates of the position of the point where the user ends the mountain climbing, the coordinates of the position of each representative point (such as peak, rest location) on the route, the overall length of the mountain climbing route, the difference in altitude across the mountain climbing route, and a variety of other pieces of information associated with the mountain climbing route.

### 1-7-2. Data Stored in Memory Section of Information Terminal

The memory section 24 of the information terminal 2 stores, for example, the following data:

### (1) Program

The program memorized by the memory section 24 of the information terminal 2 is a program executed by the processing section 21 of the information terminal 2. The program is a program for receiving necessary information provided by the main server 4 (application program).

### (2) Temporary Saved Data

The temporary saved data are, for example, measured data read from the electronic apparatus 1 and data downloaded from the main server 4. It is acceptable that the data described above are temporarily memorized in the memory section 24 of the information terminal 2.

### 1-7-3. Data Stored in Memory Section of Main Server

The memory section 44 of the main server 4 stores, for example, the following data:

### (1) Program

The program memorized in the memory section 44 of the main server 4 is a program executed by the processing section 41 of the main server 4.

### (2) Database on a User Basis

The database on a user basis is a database in which mountain climbing plan data files saved by the user via the information terminal 2 are accumulated. A mountain climbing plan data file is managed, for example, on a user basis and on a date basis. A mountain climbing plan data file contains a file of data on a mountain climbing plan created by the user with the aid of a main application program. Measured data uploaded by the user via the information terminal 2 is written on the file as appropriate. The measured data written on a file of data on a mountain climbing plan is measured data on mountain climbing performed in accordance with the mountain climbing plan.

### 1-7-4. Data Stored in Memory Section of Weather Server

The memory section 54 of the weather server 5 stores, for example, the following data.

### (1) Program

The program memorized in the memory section 54 of the weather server 5 is a program executed by the processing section 51 of the weather server 5.

### (2) Weather Data

The weather data are data on the air temperature, the humidity, the atmospheric pressure, the amount of rainfall, the air flow rate, and other factors at each location. The data on the weather contains actually measured data and predicted data.

### 1-8. Embodiment

### 1-8-1. Overview of Embodiment

The user first performs mountain climbing (that is, travels along mountain climbing route) with the electronic apparatus 1 worn on the user and accumulates measured data in the memory section 130 of the electronic apparatus 1. The measured data are time series data formed of data sequentially outputted during the mountain climbing from the variety of sensors incorporated in the electronic apparatus 1 with the data related to time.

The measured data contains information specific to the mountain climbing route (such as position coordinates), information on the user's body (such as heart rate) during the travel along the mountain climbing route, and information on the environment (such as atmospheric pressure) around the user during the travel. The measured data allow, for example, generation of the activity period, biological information, an index of the rate of perceived exertion (RPE), the accumulated altitude difference, and other pieces of information.

After the mountain climbing, when the user uploads the measured data to the main server 4, the measured data is written on a relevant file in to the user's database.

In the main server 4, the memory section 44 keeps databases in which measured data inputted by a large number of users are stored on a mountain climbing route basis. Whenever a user uploads measured data, the main server 4 updates the corresponding database. The present embodiment will be described with reference to the individual database for the user of the electronic apparatus 1. That is, the “database” used in the following description is the individual database for the user of the electronic apparatus 1.

The main server 4 communicates with the weather server 5 as required or on a regular basis and updates the database. The update is the process of adding weather data to a relevant location of a file registered in the database. The weather data are, for example, weather data at each point on a mountain climbing route at the timing when the user passes through the point.

The main server 4 then prompts the user to input a condition via the information terminal 2, ranks a plurality of mountain climbing routes registered in the database under the inputted condition, and causes the display section 25 of the information terminal 2 or any other component to display a result of the ranking.

The condition is, for example, “a mountain climbing route found to be exertive,” “a mountain climbing route that requires a long activity period,” and “a high-altitude mountain climbing route.” That is, the user can set an index desired by the user (see FIG. 7) as an index (example of reference) used in the ranking.

The main server 4 can further prompt the user to input a restricting condition (example of reference) via the information terminal 2. The restricting condition is range limitation imposed on a mountain climbing route to be ranked. Examples of the restricting condition that can be inputted by the user include the area, the activity period, the mountain climbing time of the year, and the mountain climbing route distance.

For example, the user can set the area to which a mountain climbing route to be ranked belongs to be an area desired by the user (only within Nagano Prefecture, for example) , set the length of the activity period required for travel across a mountain climbing route to be ranked to be a period desired by the user (longer than or equal to two hours but shorter than or equal to five hours, for example), or set the mountain climbing time of the year when the user travels a mountain climbing route to be ranked to be the time of the year desired by the user (only spring or summer, for example).

Further, for example, the user can specify the number of mountain climbing routes to be displayed as a result of the ranking. For example, the user can restrict the number of mountain climbing routes to be displayed as a result of the ranking to “only top-five mountain climbing routes” or “to only top-ten mountain climbing routes.”

The main server 4 may allow the user to set at least two of the conditions described above at the same time. Further, the main server 4 can perform the ranking with a plurality of specified conditions weighted in the case where the user can specify a plurality of indices at the same time (although will be described later in detail, “weighting” is action corresponding to setting of allocation in blend, which will be described later).

The information terminal 2 notifies the user of a result of the ranking on the basis of information received from the main server 4. The information terminal 2 may display the result of the ranking in the form of a list or may display the ranking in the form of numerals on a map.

The system according to the present embodiment performs the basic action described above to allow the user to check the ranking of a plurality of mountain climbing routes . At this point, objective data associated with each of the mountain climbing routes can be simultaneously displayed. Therefore, for example, in a case where the plurality of mountain climbing routes include only one mountain climbing route that has caused the user to feel extreme fatigue, the system can objectively convey the fact to the user.

### 1-8-2. Specific Example of Ranking

The processing section 41 of the main server 4 includes a selection section that selects a reference (index, restricting condition) for ranking a plurality of mountain climbing routes registered in the database, a ranking section that ranks the plurality of mountain climbing routes on the basis of the selected reference (index, restricting condition), and an outputs section that outputs a result of the ranking or the ranked routes. In other words, the processing section 41 carries out the step of selecting a reference (index, restricting condition) for ranking a plurality of mountain climbing routes registered in the database, the step of ranking the plurality of mountain climbing routes on the basis of the selected reference (index, restricting condition), and the step of outputting a result of the ranking or the ranked routes.

The “selection” used herein includes selection performed in response to an instruction from the user and selection automatically performed by the processing section 41. In the following description, it is assumed that the selection is performed in response to an instruction from the user. The “output” used herein may be any of an output in the form of an image, light, sound, vibration, and information, and the output destination may be the user or an apparatus. The following description will be primarily made of the case where an output in the form of an image is employed, and it is assumed that the output destination is the user.

For example, the processing section 41 of the main server 4 displays “top-ten exertive mountain climbing routes” among the mountain climbing routes along which the user traveled in the past. The idea described above is an application of the idea of “100 famous mountains in Japan,” and the purpose of the idea will be described below. It is, however, noted that the present embodiment does not necessarily achieve all the following objectives and may achieve only part of the following objectives.

(1) The user is allowed to create the user's best mountain climbing route on the basis of the user's experiences.

(2) The user is allowed to objectively recall past mountain climbing that the user vaguely remembers.

(3) The user is prompted to create a variety of user's best mountain climbing routes by changing the reference (index) of the ranking.

(4) The user is allowed to arbitrarily introduce another reference (restricting condition). For example, the user sets the range of mountain climbing routes to be ranked to be “mountains higher than or equal to an altitude of 2000 m,” “only mountain climbing routes for trail running,” “easy mountains,” “mountains with large altitude difference,” “mountains only within Nagano Prefecture,” “only brand mountains (famous mountains),” and “only conquered mountains.”

(5) The user is allowed to freely blend a plurality of indices (see FIG. 7) relating to mountain climbing routes.

### 1-8-3. Ranking-Related Screens

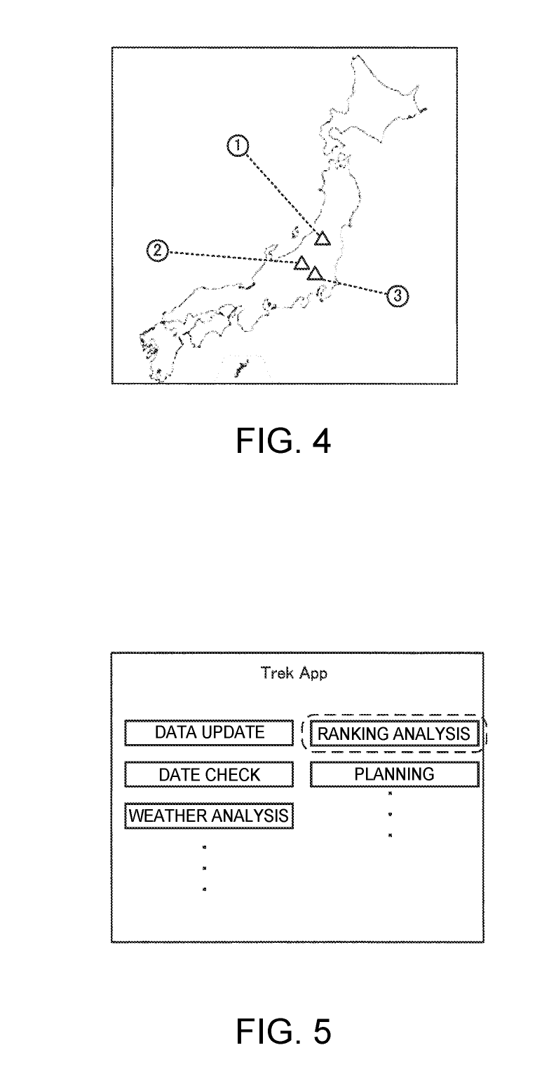

In the system according to the present embodiment, the processing section 41 of the main server 4 presents a plurality of mountain climbing routes in the ranking order (see FIG. 4). In this case, the user can recognize the ranks of the mountain climbing routes in the presented order. The processing section 41 of the main server 4 further displays the plurality of ranked mountain climbing routes along with the ranking of the mountain climbing routes on a map, as shown in FIG. 4. In this case, the user can intuitively grasp the correspondence between the positions of the mountain climbing routes and the ranks thereof on the map.

The place where the ranking and the map are displayed is the display section 25 of the information terminal 2. The processing section 41 of the main server 4 transmits image data for displaying the ranking and the map to the information terminal 2 over the network 3 in response to a request from the information terminal 2. The processing section 21 of the information terminal 2 causes the display section 25 to display an image of the ranking and the map on the basis of the image data received from the main server 4. FIG. 4 will be described later in detail.

The ranking is obtained on the basis of a statistical analysis approach. To evaluate a mountain climbing route, biological information on the user who has traveled along the mountain climbing route (such as data on heart rate) and motion information on the user who has traveled along the mountain climbing route (such as acceleration data) are used as indices for evaluating the mountain climbing route. Since the indices are each a numerical index, the reference of the ranking can be flexibly changed.

### 1-8-4. Setting Involved in Ranking

In the system according to the present embodiment, the reference (index) of the ranking is formed of a plurality of references (indices) different from one another, and the processing section 41 of the main server 4 performs the ranking by weighting each of the plurality of references (indices). Ina case where a first reference (index) and a second reference (index) relating to a mountain climbing route are used as the plurality of references (indices), ranking primarily using the first reference (index) and ranking primarily using the second reference (index) can be performed. Further, ranking in which the allocation ratio between the importance of the first reference (index) and the importance of the second reference (index) is set at a predetermined allocation ratio can also be performed. In the system according to the present embodiment, the weighting is specified by the user. The user can therefore set the allocation ratio between the importance of the first reference (index) and the importance of the second reference (index) at the user's preferred allocation ratio. A specific description will be made below.

To perform the ranking, the main server 4 first causes the information terminal 2 to display a variety of setting screens to prompt the user to perform a variety of settings. At this point, the information terminal 2 communicates with the main server 4 in accordance with the application program, receives data on a variety of images from the main server 4, and causes the display section 25 to display the variety of images. Details of the communication between the main server 4 and the information terminal 2, how the main server 4 causes the display section 25 of the information terminal 2 to display an image, and other factors are known, and no description thereof will therefore be made.

The application program has a function necessary to allow the user to receive information on mountain climbing provided from the main server 4. The application program is, for example, provided from the main server 4 over the network 3. The application program is stored in the memory section 24 of the information terminal 2. In the following description, it is assumed that the application program in the present embodiment uses the touch panel displays (operation section 23 and display section 25) of the information terminal 2 as a user interface.

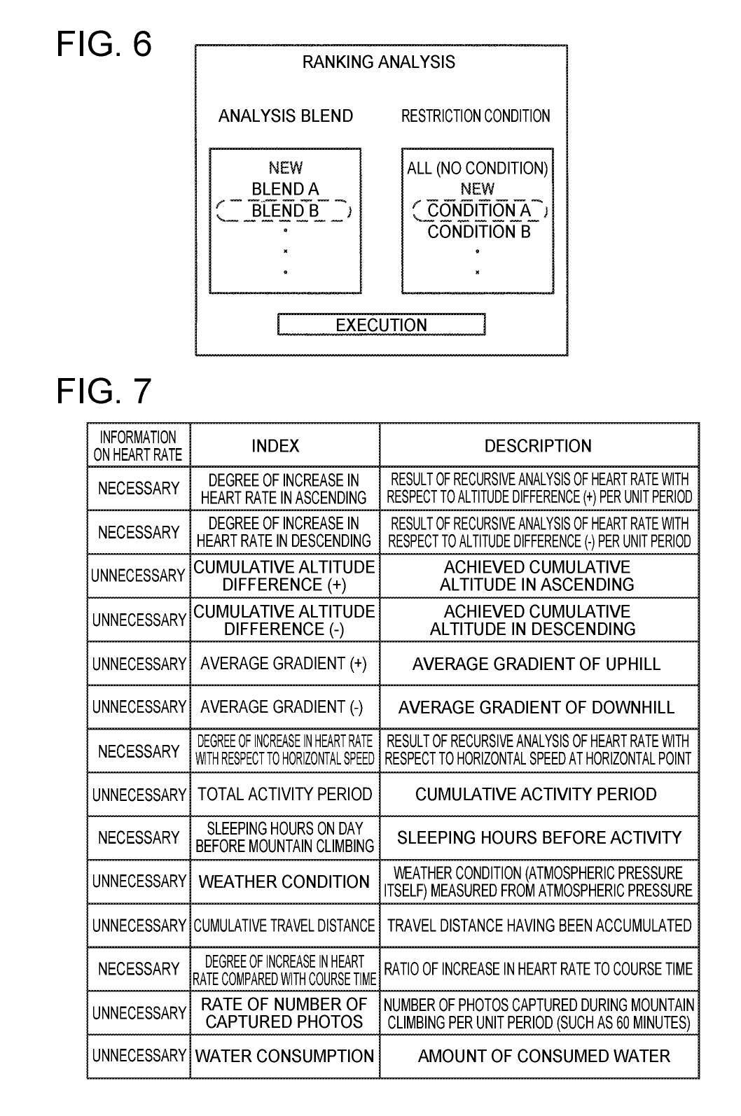

A data update button, a ranking analysis button, a data check button, a planning button, a weather analysis button, and other buttons are arranged in an initial display screen (referred, for example, to as home screen and top screen), as shown in FIG. 5. When the user taps any of the buttons with a finger, the display section 25 displays a screen assigned to the tapped button. For example, when the user tapped the ranking analysis button disposed in an upper right portion of the screen in the plane of view of FIG. 5, the display section 25 displays a ranking analysis setting screen shown in FIG. 6. In the following description, it is assumed that the user's selection of an item on the screen is performed by the user's “tapping” with a finger.

As shown in FIG. 6, on the ranking analysis setting screen are arranged a box in which candidates of an analysis blend (hereinafter simply referred to as “blend”) are listed (lower left side in the plane of view of FIG. 6), a box in which candidates of the restriction condition are listed (lower right side in the plane of view of FIG. 6), and an execution button (lowest in the plane of view of FIG. 6).

The term “blend” means a combination of indices to be used when the ranking of mountain climbing routes is performed and the allocation ratio among the indices. The term “index” means a variety of indices relating to the “exertion” of a mountain climbing route (see FIG. 7), and the term “restriction condition” means the range of a mountain climbing route to be ranked.

The user can tap any one of the blend candidates arranged in the left box in the plane of view of FIG. 6 to select the candidate and tap any one of the restriction condition candidates arranged in the right box to select the restriction condition. The example in FIG. 6 shows that a “blend B” and a “condition A” have been selected. The candidates indicated by the dotted-line frames in FIG. 6 represent candidates being selected (the same holds true in the following description).

In this process, the user can select a blend candidate registered in advance or can register a blend candidate by himself/herself as will be described later. In the screen shown in FIG. 6, the user can cause a screen that allows the user to register a new blend to be displayed by tapping the candidate labeled with “New.” How the new registration and the in-advance registration work will be described later.

When the user taps the execution button disposed in the screen shown in FIG. 6, the information terminal 2 transmits the candidate selected at the time of the tapping (blend B, condition A) to the main server 4 over the network 3. The processing section 41 of the main server 4 ranks a plurality of mountain climbing routes on the basis of the database for the user of the information terminal 2 (user of electronic apparatus 1) and the received candidates (blend B, condition A) and transmits image data on a screen containing a result of the ranking to the information terminal 2 over the network 3. The information terminal 2 causes the display section 25 to display the result of the ranking on the basis of the received image data (FIG. 4 and other figures). The procedure of the ranking using the blend B and the condition A and performed by the processing section 41 will be briefly described below.

(1) The processing section 41 selects from the database only mountain climbing routes that satisfy the condition A as mountain climbing routes to be ranked. For example, the processing section 41 selects files relating to mountain climbing routes that satisfy the condition A on the basis of information attached to a plurality of mountain climbing plan data files registered in the database (such as database management information, file tag information).

(2) The processing section 41 calculates indices from the plurality of selected files (plurality of sets of mountain climbing routes). The indices are formed of one index or a plurality of indices specified by the blend B.

(3) The processing section 41 weights the one index or the plurality of indices extracted from the individual files (data on mountain climbing routes) with the allocation ratio specified by the blend B to calculate a total index of each of the individual files (individual sets of data on mountain climbing routes). The weighting can be performed, for example, by using the sum of the weighted one index or the plurality of weighted indices.

(4) The processing section 41 ranks the plurality of selected files (data on plurality of mountain climbing routes) in the descending (or ascending) order of the total index.

It is noted that a button (not shown) that allows the current screen to transition to the initial display screen (FIG. 5) maybe disposed in each of a variety of display screens that will be described below.

1-8-5. Index Associated with Mountain Climbing Route

The index associated with a mountain climbing route will be specifically described below. The index associated with a mountain climbing route is an index relating to “exertion” of the mountain climbing route, that is, an index representing the difficulty level of the mountain climbing route. It is, however, noted that since the “exertion” includes a variety of kinds of “exertion,” the processing section 41 of the main server 4 calculates a variety of indices by using combinations of measured data. FIG. 7 shows several exemplary indices that the processing section 41 can calculate. The processing section 41 calculates one or more of the plurality of indices shown in FIG. 7 on the basis of measured data associated with a mountain climbing route (measured data stored along with mountain climbing route in mountain climbing plan data file) . The content of each of the indices (and method for calculating index) is as follows.

### (1) Degree of Increase in Heart Rate in Ascending:

The degree of increase in the heart rate in ascending is a result of recursive analysis of the heart rate with respect to the altitude difference (+) per unit period. The altitude at each point on the mountain climbing route can be determined on the basis of the position coordinate data produced by the GPS sensor 110, the atmospheric pressure data produced by the atmospheric pressure sensor 112, and other data. The heart rate can be determined on the basis of the pulse data produced by the pulse sensor 115. The period can be obtained on the basis of the clocking data produced by the clocking section 160.

### (2) Degree of Increase in Heart Rate in Descending:

The degree of increase in the heart rate in descending is a result of recursive analysis of the heart rate with respect to the altitude difference (+) per unit period. The altitude at each point on the mountain climbing route can be determined on the basis of the position coordinate data produced by the GPS sensor 110, the atmospheric pressure data produced by the atmospheric pressure sensor 112, and other data. The heart rate can be determined on the basis of the pulse data produced by the pulse sensor 115. The period can be obtained on the basis of the clocking data produced by the clocking section 160.

### (3) Cumulative Altitude Difference (+):

The cumulative altitude difference (+) is the cumulative altitude that the user has achieved during the ascending travel along the mountain climbing route. The altitude at each point on the mountain climbing route can be determined on the basis of the altitude data produced by the GPS sensor 110, the atmospheric pressure data produced by the atmospheric pressure sensor 112, and other data. Since the altitude at each point on the mountain climbing route is basically unchanged, the altitude data contained in the measured data may be replaced with altitude data registered as the mountain climbing plan data.

### (4) Cumulative Altitude Difference (−):

The cumulative altitude difference (−) is the cumulative altitude that the user has achieved during the descending travel along the mountain climbing route. The altitude at each point on the mountain climbing route can be determined on the basis of the altitude data produced by the GPS sensor 110, the atmospheric pressure data produced by the atmospheric pressure sensor 112, and other data. Since the altitude at each point on the mountain climbing route is basically unchanged, the altitude data contained in the measured data may be replaced with altitude data registered as the mountain climbing plan data.

### (5) Average Gradient (+):

The average gradient (+) is the average degree of inclination of the uphill contained in the mountain climbing route. The position coordinates at each point on the mountain climbing route can be determined on the basis of the position coordinate data produced by the GPS sensor 110, the atmospheric pressure data produced by the atmospheric pressure sensor 112, and other data. Since the position coordinates at each point on the mountain climbing route is basically unchanged, the position coordinate data contained in the measured data may be replaced with position coordinate data registered as the mountain climbing plan data.

### (6) Average Gradient (−):

The average gradient (−) is the average degree of inclination of the downhill contained in the mountain climbing route. The position coordinates at each point on the mountain climbing route can be determined on the basis of the position coordinate data produced by the GPS sensor 110, the atmospheric pressure data produced by the atmospheric pressure sensor 112, and other data. Since the position coordinates at each point on the mountain climbing route is basically unchanged, the position coordinate data contained in the measured data may be replaced with position coordinate data registered as the mountain climbing plan data.

(7) Degree of Increase in Heart Rate with Respect to Horizontal Speed:

The degree of increase in the heart rate with respect to the horizontal speed is a result of recursive analysis of the heart rate with respect to the horizontal speed at a horizontal point. The position coordinates at each point on the mountain climbing route can be determined on the basis of the position coordinate data produced by the GPS sensor 110, the atmospheric pressure data produced by the atmospheric pressure sensor 112, and other data. The heart rate can be determined on the basis of the pulse data produced by the pulse sensor 115. Since the position coordinates at each point on the mountain climbing route is basically unchanged, the position coordinate data contained in the measured data may be replaced with position coordinate data registered as the mountain climbing plan data.

### (8) Total Activity Period:

The total activity period is the period required for the travel across the mountain climbing route, that is, the cumulative activity period across the mountain climbing route. The period can be calculated on the basis of the clocking data produced by the clocking section 160 at the start point of the mountain climbing route and the measured data produced by the clocking section 160 at the end point of the mountain climbing route.

### (9) Sleeping Hours on Day Before Mountain Climbing:

The sleeping hours on the day before the mountain climbing are the sleeping hours on the day (in the night) before the user travels along the mountain climbing route. The sleeping hours can be estimated on the basis of the acceleration data produced by the acceleration sensor 113 in a predetermined period before the user starts the mountain climbing and pulse data produced by the pulse sensor 115 in the predetermined period before the user starts the mountain climbing. The data on the sleeping hours may instead be manually inputted by the user. The electronic apparatus 1 may add data necessary for the estimation of the sleeping hours (data on acceleration and pulse in predetermined period before user starts mountain climbing) to measured data relating to the mountain climbing route and transmit the resultant data to the information terminal 2 or may add sleeping hour data itself to measured data relating to the mountain climbing route and transmit the resultant data to the information terminal 2. The information terminal 2 may upload the data necessary for the estimation of the sleeping hours (data on acceleration and pulse in predetermined period before user starts mountain climbing) to the measured data relating to the mountain climbing route and upload the resultant data to the main server 4 or may add the sleeping hour data itself to the measured data relating to the mountain climbing route and upload the resultant data to the main server 4.

### (10) Weather Condition:

The weather condition is a weather condition (atmospheric pressure itself) measured from the atmospheric pressure. The atmospheric pressure can be calculated on the basis of the atmospheric pressure outputted from the atmospheric pressure sensor 112.

### (11) Cumulative Travel Distance:

The cumulative travel distance is the distance accumulated over the mountain climbing route. The coordinates at each point on the mountain climbing route can be determined on the basis of the position coordinate data produced by the GPS sensor 110, the atmospheric pressure data produced by the atmospheric pressure sensor 112, and other data. Since the position coordinates at each point on the mountain climbing route is basically unchanged, the position coordinate data contained in the measured data may be replaced with position coordinate data registered as the mountain climbing plan data.

(12) Degree of Increase in Heart Rate Compared with Course Time:

The degree of increase in the heart rate compared with the course time is the ratio of an increase in the heart rate to the course time. The heart rate can be determined on the basis of the pulse data produced by the pulse sensor 115. The course time can be obtained on the basis of the clocking data produced by the clocking section 160.

### (13) Rate of Number of Captured Photos:

The rate of the number of captured photos is the number of photos captured by the user during the travel along the mountain climbing route per unit period (such as 60 minutes) . For example, the history of photographing may be manually inputted by the user or may be automatically acquired by the information terminal 2. The processing section 21 of the information terminal 2 acquires the photographing history during the mountain climbing on the basis of the date of each image file sored in the memory section 24 of the information terminal 2 and uploads the photographing history along with the measured data to the main server 4.

### (14) Water Consumption:

The water consumption is the amount of water consumed by the user during the travel along the mountain climbing route. The amount of water can, for example, be manually inputted by the user to the information terminal 2. The processing section 21 of the information terminal 2 uploads the inputted amount of water along with the measured data to the main server 4.

Before performing the ranking, the processing section 41 of the main server 4 then prompts the user to specify (perform weighing) the combination of a plurality of the indices and the allocation (in other words, weight or any other term) of the indices. The weighting is specified in the information terminal 2 by a user. The “blend” described above refers to the combination and allocation of the indices specified by the user.

For example, the user selects three indices, the “degree of increase in heart rate in ascending,” the “degree of increase in heart rate in descending,” and the “total activity period, ” from the indices shown in FIG. 7 and specifies the allocation of the selected indices, for example, as follows: the degree of increase in the heart rate in ascending is 40%; the degree of increase in the heart rate in descending is 40%; and the total activity period is 20%.

According to the aforementioned combination and allocation (that is, blend) of the indices, in the case of a mountain climbing route along which the user slowly walks to suppress an increase in the heart rate, the suppression of the degree of increase in the heart rate causes 80% of the “exertion” to decrease, but the increase in the total activity period causes 20% of the “exertion” to increase. Therefore, according to the blend, the shorter the activity period required by a mountain climbing route, the higher the overall presented “exertion.”

Instead, for example, the user selects the degree of increase in the heart rate in ascending, the degree of increase in the heart rate in descending, and the total activity period from the indices shown in FIG. 7 and sets the allocation of the selected indices as follows: the degree of increase in the heart rate in ascending is 10%; the degree of increase in the heart rate in descending is 10%; and the total activity period is 80%.

According to the blend described above, in the case of a mountain climbing route along which the user slowly walks to suppress an increase in the heart rate, the suppression of the degree of increase in the heart rate causes 20% of the “exertion” to decrease, but the increase in the total activity period causes 80% of the “exertion” to increase. Therefore, in this case, the longer the activity period required by a mountain climbing route, the higher the overall presented “exertion.”

As described above, since the exertion of a mountain climbing route greatly varies depending on indices that are blended and the allocation of the blended indices, a result of the ranking of the mountain climbing route greatly changes.

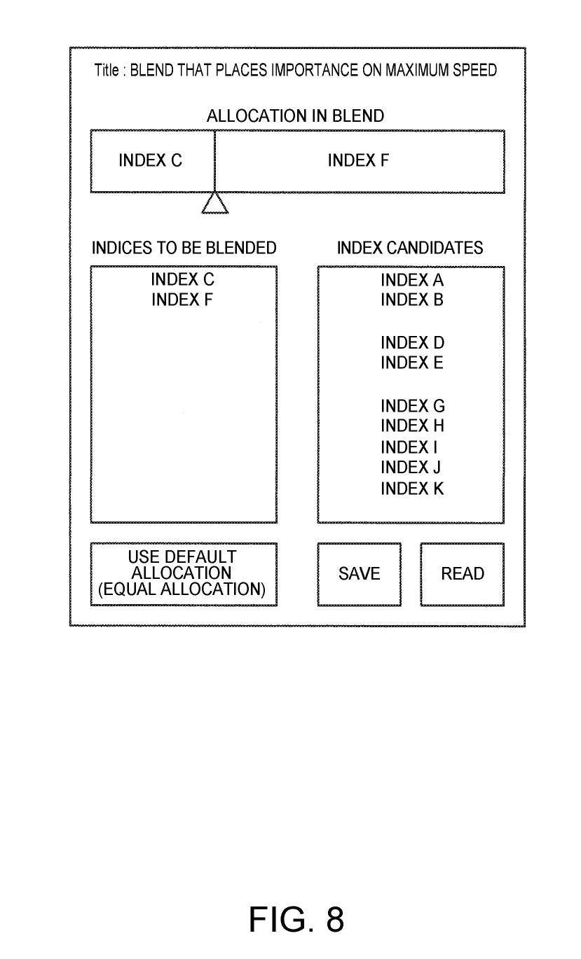

The processing section 41 of the main server 4 saves blends registered in advance as templates in the memory section 44 and provides the user with the templates as required. On the other hand, the user, when registering a blend, imparts a desired name to the blend so that the blend is readily managed. FIG. 8 shows an example of a screen for inputting and managing a blend. Image data for displaying the screen is transmitted from the main server 4 to the information terminal 2 over the network 3. The processing section 21 of the information terminal 2 causes the display section 25 to display the screen shown in FIG. 8 on the basis of the image data.

In an upper portion FIG. 8 in the plane of view thereof are arranged the name of a blend (Title), that is, “Blend that places importance on maximum speed,” and a band-shaped allocation graph representing the allocation in the blend. In a left portion FIG. 8 in the plane of view thereof is displayed a box in which the names of indices to be blended (indices C and F) are arranged, and in a right portion in the plane of view thereof is displayed a box in which index candidates (indices A, B, . . . ) are arranged. In a lower portion FIG. 8 in the plane of view thereof are displayed a button for using a default allocation (equal allocation), a button for saving the blend, and a button for reading a blend.

The allocation graph shown in FIG. 8 may be so drawn that indices different from each other are color-coded and displayed. For example, the area of the index C and the area of the index F in the allocation graph shown in FIG. 8 may be displayed in different colors.

The user can edit the blend on the screen shown in FIG. 8. The mark (lever) indicated by the triangle in FIG. 8 is a “partition” for changing the allocation in the blend. The lever is disposed at the boundary between the index C and the index F, and when the user causes with a finger the lever to slide in the rightward/leftward direction in the plane of view, the allocation of the index C and the index F changes. The mark representing the lever is not limited to a triangle mark.

The box in which index candidates selectable by the user are arranged is displayed in the right portion FIG. 8 in the plane of view thereof. The user can move one of the candidates arranged in the right box in the plane of view of FIG. 8 into the left box, for example, with the aid of drag-and-drop operation (touch-and-slide operation) to add the candidate as one of the indices to be blended.

At this point, the content of the allocation graph disposed in the upper portion in the plane of view of FIG. 8 is also updated. In the allocation graph, the proportion of a newly added index is set at a default value (for example, 10%, it is however noted that the proportion is 99% when an index is newly registered).

Further, the user can move an unnecessary candidate from the left box in the plane of view of FIG. 8 to an area outside the box, for example, with the aid of drag-and-drop operation (touch-and-slide operation) to exclude the candidate from the indices to be blended.

The user can then cause the lever provided at the allocation graph in FIG. 8 to slide to adjust the allocation of the indices again.

In the present system, the number of indices that are allowed to be blended is arbitrarily determined. However, if the number of indices is significantly large, the operability deteriorates. The processing section 41 of the main server 4 may therefore limit the number of indices selectable by the user.

The processing section 41 of the main server 4 then saves the content of the blend displayed on the screen shown in FIG. 8. For example, when the user taps the save button disposed in a lower central portion in the plane of view of FIG. 8, the information terminal 2 transmits the content displayed on the screen at the time of the tapping (content of blend) to the main server 4 over the network 3. The main server 4, when it receives the content of the blend, writes the content of the blend in the form of a file on the memory section 44. The information terminal 2 may instead prompt the user to specify the file name of the file (name of blend) and transmit the file name along with the content of the blend to the main server 4. The processing section 41 of the main server 4 saves the file with the file name attached thereto in the memory section 44. The blend created by the user has thus been registered.

The user can therefore readily use the saved (registered) blend as required.

The button for reading the content of a saved (registered) blend (read button) is disposed in a lower right portion of FIG. 8 in the plane of view thereof, and when the user taps the read button, the display section 25 displays a list of saved (registered) blends (list of names of blends). When the user taps a desired blend, the content of the blend can be reflected on the screen.

Further, the user may be capable of sharing the blends saved (registered) in the main server 4 with another person.

In this case, the processing section 41 of the main server 4 discloses the blends saved in the memory section 44 to another person after receiving permission to do so from the user who is the creator of the blends.

That is, the processing section 41 of the main server 4, when it saves (registers) the content of a blend received from the information terminal 2 of a user in the memory section 44, asks the user whether or not the user permits disclosure of the content of the blend, and when the user permits the disclosure, the processing section 41 sets the blend to be disclosed.

Further, the processing section 41 of the main server 4, when it transmits blend candidates to the information terminal 2 of a user in response to a request from the user, sets blends being disclosed as the candidates.

Existing technologies can be applied to the mechanism involved in the discloser/non-disclosure of data uploaded by the user, including a security aspect.

The indices can each be determined from measured data obtained when the user travels a mountain climbing route, as described above. It is, however, noted that when the processing section 41 of the main server 4 calculates the indices relating to a mountain climbing route, the indices associated with the mountain climbing route are desirably written on a file relating to the mountain climbing route because it is inefficient to calculate the indices whenever the processing section 41 of the main server 4 performs the ranking. The processes carried out by the processing section 41 in the second and later ranking operation can therefore be efficiently carried out.

The indices are classified into two kinds, indices that can be successively measured during mountain climbing (measured data themselves) and indices that can be measured only after the mountain climbing (indices required to undergo series of measured data statistical processing). The statistical processing includes linear recursive analysis, simple arithmetic average, maximum calculation, and minimum calculation.

### 1-8-6. Restriction Condition

The processing section 41 of the main server 4 can add a restriction condition relating to a mountain climbing route to be ranked. The restriction condition is a condition to be satisfied by a mountain climbing route to be ranked. That is, a mountain climbing route that does not satisfy a restriction condition is excluded from those to be ranked. The restriction condition can, for example, be the following conditions.

(1) only mountain climbing routes that require an activity period longer than or equal to two hours

(2) only mountain climbing routes along which trail running has been performed

(3) only mountain climbing routes in Nagano Prefecture

(4) only mountain climbing routes on the 100 famous mountains in Japan

The kind of travel having been performed on a mountain climbing route can be manually inputted by the user via the electronic apparatus 1 or the information terminal 2. The kind of travel can instead be automatically detected by the processing section 41 of the main server 4 on the basis of measured data associated with a mountain climbing route (acceleration data, angular velocity data, and position coordinate data, for example).

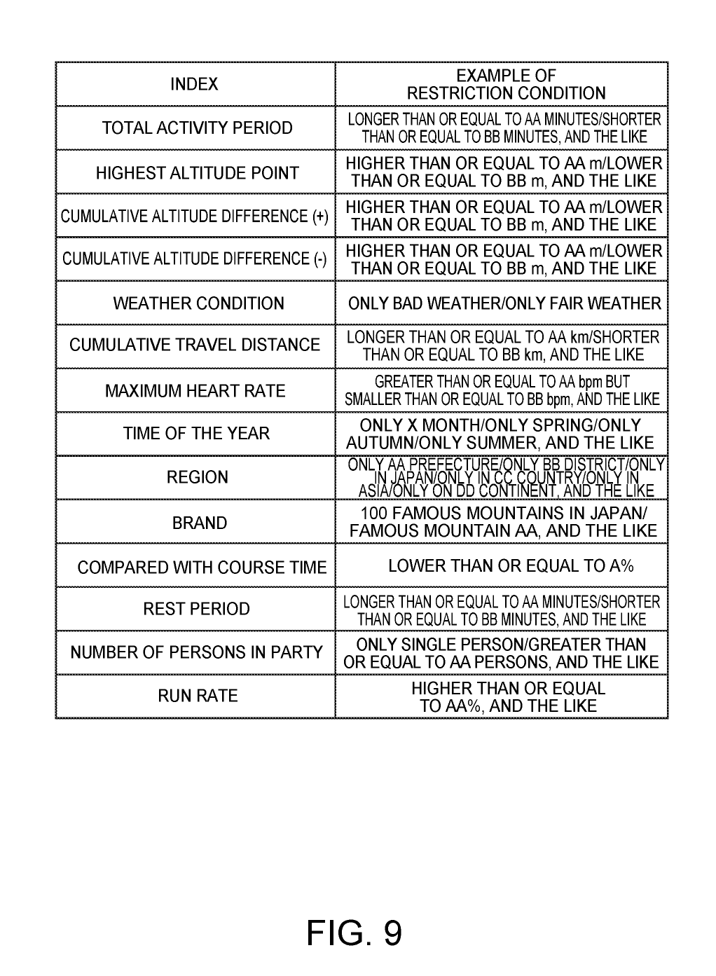

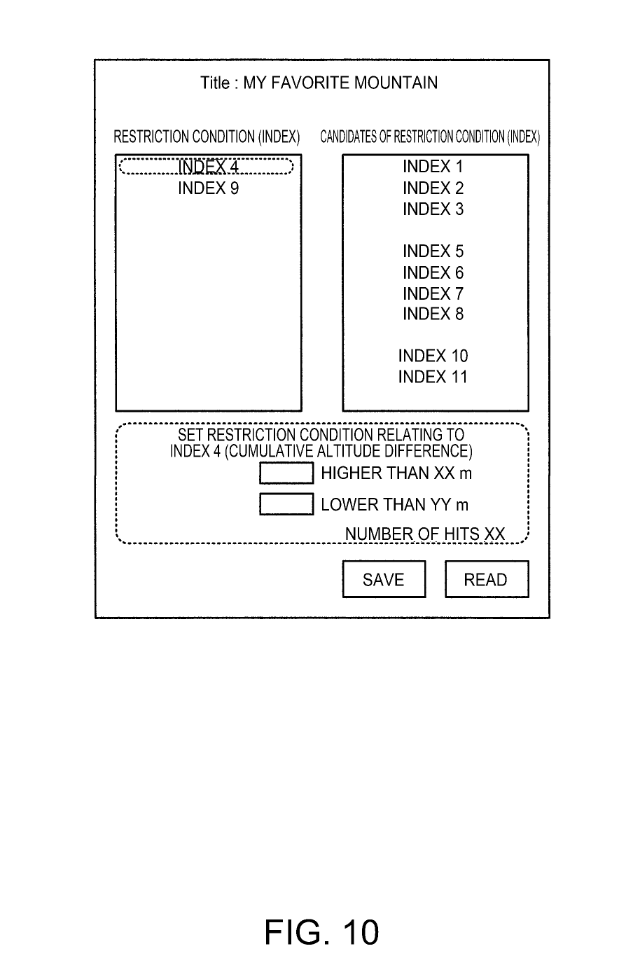

The restriction condition may instead be determined by using a template, such as that shown in FIG. 9. The restriction condition relates to an index associated with a mountain climbing route. The information shown on the left in the plane of view of FIG. 9 is an index relating to the restriction condition, and the information shown on the right in the plane of view of FIG. 9 is a method for specifying a restriction condition using the index. The user can, for example, set a restriction condition on the screen shown in FIG. 10.

The screen shown in FIG. 10 is an example of the screen for setting the restriction condition. The name (title) of the restriction condition, “My favorite mountain,” is disposed in an upper portion of FIG. 10 in the plane of view thereof. Abox in which indices (indices 4 and 9) used in the restriction condition are arranged is displayed in a left portion of FIG. 10 in the plane of view thereof, and a box in which index candidates (indices 1, 2, 3, 5, 6, 7, 8, 10, and 11) are arranged is displayed in a right portion of FIG. 10 in the plane of view thereof.

The user can move one of the candidates arranged in the right box in the plane of view of FIG. 10 into the left box, for example, with the aid of drag-and-drop operation (touch-and-slide operation) to add the restriction condition specified by the candidate as one of the restriction conditions under which the ranking is performed.

The user can tap any of the indices in the left box in the plane of view of FIG. 10 to make the index selected.

When an index is selected, the screen shown in FIG. 10 displays a restriction condition setting screen using the selected index (see portion within dotted-line frame in lower portion of FIG. 10 in plane of view thereof). The setting screen is a screen that prompts the user to input an upper limit and a lower limit (range) of the index 4 (cumulative altitude difference) being selected. The processing section 21 of the information terminal 2 may prompt the user to directly input the upper and lower limits or may prompt the user to select the upper and lower limits from candidates, such as 1000 m, 2000 m, and 3000 m.

At this point, the information terminal 2 transmits the index being selected and the range being set as the restriction condition to the main server 4 over the network 3. The processing section 41 of the main server 4, when it receives the restriction condition, refers to the database and counts mountain climbing routes (number of hits) that satisfy the restriction condition, which requires the index to fall within the range, and transmits the number of hits to the information terminal 2 over the network 3. Therefore, when the user widens the range, the number of hits increases, whereas when the user narrows the range, the number of hits decreases.

The processing section 41 of the main server 4 then prompts the user to save the content of the restriction condition set on the screen. For example, when the user taps the save button in FIG. 10, the information terminal 2 transmits the content displayed on the screen (content of restriction condition) at the time of the tapping to the main server 4 over the network 3. The main server 4 writes the content of the restriction condition in the form of a file onto the memory section 44.

The information terminal 2 may instead prompt the user to specify the file name of the file (name of restriction condition) and transmit the file name along with the content of the restriction condition to the main server 4. The processing section 41 of the main server 4, when it receives the file name along with the content of the restriction condition, saves the content of the restriction condition with the file name attached thereto in the form of a file in the memory section 44. The restriction condition created by the user has thus been registered.

The user can therefore readily use the saved (registered) restriction condition as required.

A button for reading the content of a saved (registered) restriction condition (read button) is disposed in a lower right portion of FIG. 10 in the plane of view thereof. When the user taps the read button, the display section 25 displays a list of saved (registered) restriction conditions (list of names of restriction conditions), and when the user taps a desired restriction condition, the content of the restriction condition can be reflected on the screen.

Further, the user may be capable of sharing the restriction conditions saved (registered) in the main server 4 with another person.

In this case, the processing section 41 of the main server 4 discloses the restriction conditions saved in the memory section 44 to another person after receiving permission to do so from the user who is the creator of the restriction conditions.

That is, the processing section 41 of the main server 4, when it saves (registers) the content of a restriction condition received from the information terminal 2 of a user in the memory section 41, asks the user whether or not the user permits disclosure of the content of the restriction condition, and when the user permits the disclosure, the processing section 41 sets the restriction condition to be disclosed.

The processing section 41 of the main server 4, when it transmits restriction condition candidates to the information terminal 2 of a user in response to a request from the user, sets restriction conditions being disclosed as the candidates.

Existing technologies can be applied to the mechanism involved in the discloser/non-disclosure of data uploaded by the user, including a security aspect.

### 1-8-7. Presentation of Ranking

The processing section 41 of the main server 4 transmits image data on a map in which a result of the ranking is reflected to the information terminal 2 over the network 3. The processing section 21 of the information terminal 2 causes the display section 25 to display the map on the basis of the received image data. FIG. 4 shows an example in which the position of a mountain climbing route ranked “1”, the position of a mountain climbing route ranked “2”, and the position of a mountain climbing route ranked “3” are mapped on the same map. The conceptual image of the numeral “1”, the conceptual image of the numeral “2”, and the conceptual image of the numeral “3” in FIG. 4 represent the ranking of the plurality of mountain climbing routes; the conceptual image of the numeral “1” represents the highest rank (first rank), the conceptual image of the numeral “2” represents the second rank, and the conceptual image of the numeral “3” represent the third rank.

The front end of the line segment attached to the conceptual image of the numeral “1” indicates the position of the mountain climbing route corresponding to the first rank. The front end of the line segment attached to the conceptual image of the numeral “2” indicates the position of the mountain climbing route corresponding to the second rank. The front end of the line segment attached to the conceptual image of the numeral “3” indicates the position of the mountain climbing route corresponding to the third rank.

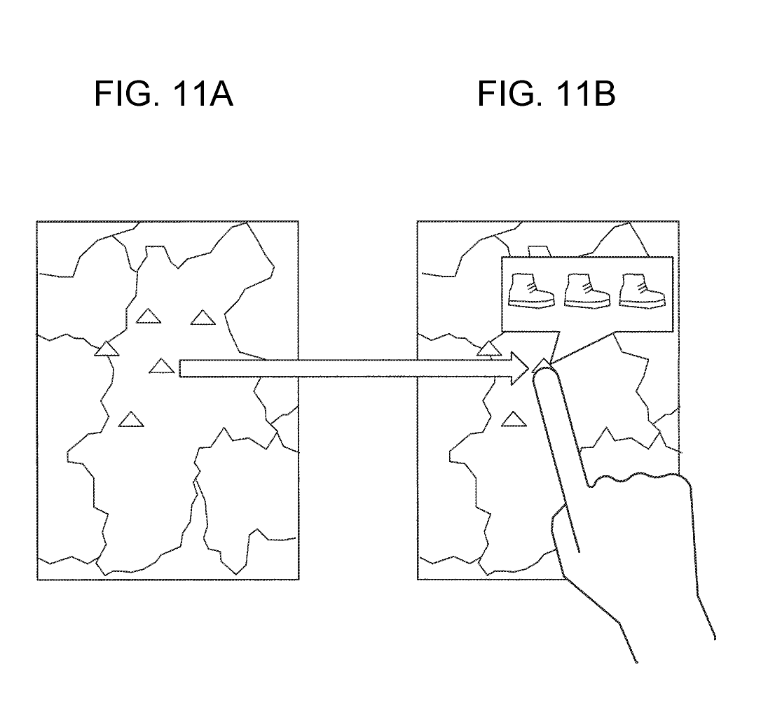

FIGS. 11A and 11B show another example of the screen on which the ranking is displayed. The screen in FIGS. 11A and 11B can also be displayed on the display section 25, as in the case of the screen in FIG. 4. FIG. 11A shows the state before a result of the ranking is displayed, and FIG. 11B shows the state after a result of the ranking is displayed.

In the screen shown in FIG. 11A, the position of each of the mountain climbing routes registered in the database is mapped in the form of a triangular mark. For example, a mountain climbing route having an altitude (maximum altitude on mountain climbing route) higher than or equal to a fixed value and a mountain climbing route having no altitude higher than or equal to the fixed value are distinguished from each other in terms of the color of the mark. It is, however, noted that any other type of color coding of the triangular marks can be employed. For example, it is conceivable to employ a method for enhancing the mark (using a red mark) of a mountain climbing route relating to a volcano or a method for enhancing the mark (using a red mark) of a mountain climbing route relating to a brand mountain (famous mountain) designated by the region or the country.

In the screen shown in FIG. 11A, when the user taps (clicks) any one of the marks, the processing section 21 of the information terminal 2 transmits data on the tapped position to the main server 4 over the network 3. The processing section 41 of the main server 4 recognizes the mountain climbing route specified by the user on the basis of the data and transmits data on the mountain climbing route (including rank thereof) to the information terminal 2 over the network 3. The data on the mountain climbing route contains at least data on the ranking result relating to the mountain climbing route (rank of mountain climbing route) and data on the exertion of the mountain climbing route.

The processing section 21 of the information terminal 2, when it receives the data on the mountain climbing route, causes the display section 25 to display the exertion contained in the data. The example shown in FIG. 11B shows a case where an icon that reflects the exertion of the mountain climbing route is displayed in the form of popup display at the location where the user has tapped with a finger. In the example shown in FIG. 11B, the degree of the exertion is expressed by the number of boot icons.

For example, assume a case where the number of mountain climbing routes to be ranked is 100 and the exertion is classified into three levels that are distinguished from one another by the number of icons ranging from 1 to 3. When the user taps a mountain climbing route that belongs to a range within which the result of the ranking (rank) ranges from 1 to 33, three icons are displayed. When the user taps a mountain climbing route that belongs to a range within which the rank ranges from 34 to 66, two icons are displayed. When the user taps a mountain climbing route that belongs to a range within which the rank ranges from 67 to 100, one icon is displayed.

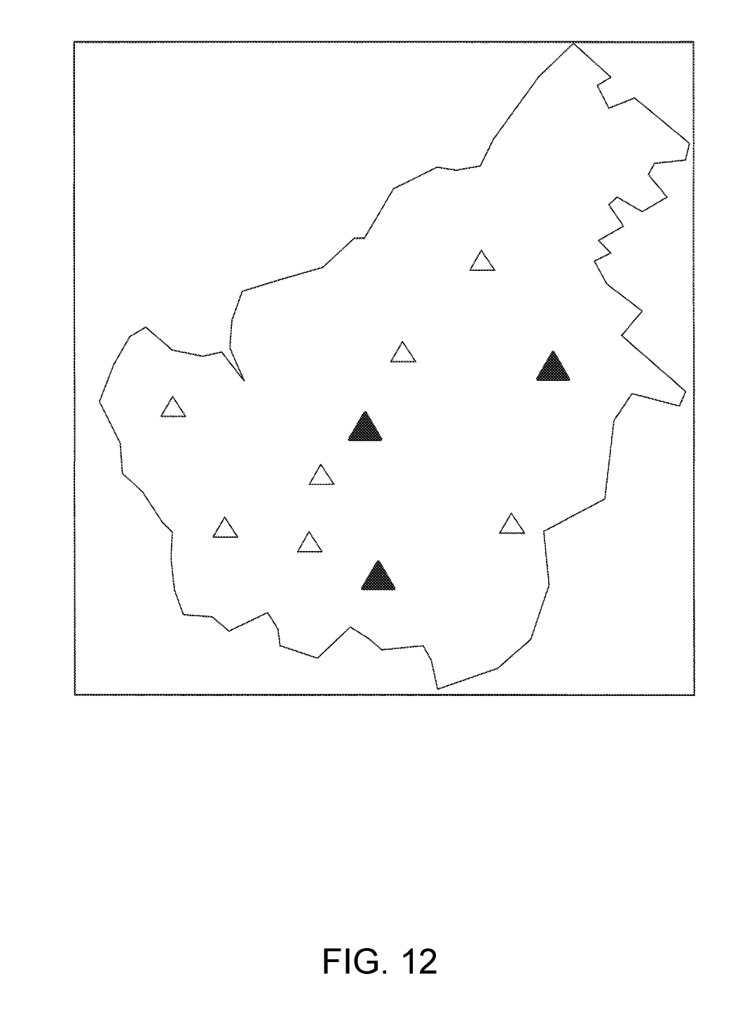

When the processing section 41 of the main server 4 causes mountain climbing routes (mountains) registered in the database to be displayed on the map, mountain climbing routes (mountains) that have not been registered in the database may also be displayed together with the registered mountain climbing routes (mountains) (see FIG. 12). In FIG. 12, a mountain climbing route (mountain) indicated by an open triangular mark is a non-registered brand mountain (for example, any of top-ten-altitude mountains), and a mountain climbing route (mountain) indicated by a filled triangular mark is a registered mountain climbing route (mountain). Therefore, no result of the ranking is displayed when the user taps (clicks) an open triangular mark, whereas a result of the ranking is displayed when the user taps (clicks) a filled triangular mark (FIG. 13).

In a case where the user has traveled at least twice along the same mountain climbing route at different times of the year, data (file) on the same mountain climbing route is registered at least twice in the database in some cases. In this case, the processing section 41 of the main server 4 can carry out the following processes.

(1) The processing section 41 causes the display section 25 of the information terminal 2 to display data on the highest rank but display no other data.

(2) The processing section 41 causes the display section 25 of the information terminal 2 to display data on the lowest rank but display no other data.

(3) The processing section 41 averages data on all ranks (average of ranks or average of indices).

(4) The processing section 41 causes the display section 25 of the information terminal 2 to display all data arranged next to each other (arrangement direction is vertical or horizontal direction in plane of view).

### 1-8-8. Inverse Calculation

The aforementioned function of the main server 4 (ranking based on blend specified by user) can also be so applied that the main server 4 can calculate a blend for maximizing the rank of a mountain (mountain climbing route) specified by the user (inverse calculation) . For example, the user specifies a mountain climbing route that the user has considered to be most exertive and finds a blend that maximizes the rank of the mountain climbing route to understand what element the user specifically considers to be exertive.

The processing section 41 of the main server 4 first causes the display section 25 of the information terminal 2 to display image data on the map shown in FIG. 12. A method for causing the display section 25 to display an image has been described above, and no description of the method will therefore be made.

In FIG. 12, a mountain climbing route (mountain) indicated by any of the open triangular marks is a mountain climbing route on what is called a brand mountain (for example, any of top-ten-altitude mountains), and a mountain climbing route (mountain) indicated by any of the filled triangular marks is a mountain climbing route (mountain) registered in the user's database.

When the user taps a filled triangular mark on the screen shown in FIG. 12 (FIG. 13), the processing section 21 of the information terminal 2 transmits data for identifying the mountain climbing route corresponding to the tapped mark to the main server 4 over the network 3. The processing section 41 of the main server 4 identifies the mountain climbing route on the basis of the data and searches for a blend that maximizes the rank of the mountain climbing route. The search for the blend is performed, for example, by referring to the ranks with the content of the blend changed (combination and allocation of indices) and detecting a blend when the rank of the mountain climbing route is maximized. Instead, the processing section 41 of the main server 4 can carry out the following processes to find an appropriate blend.

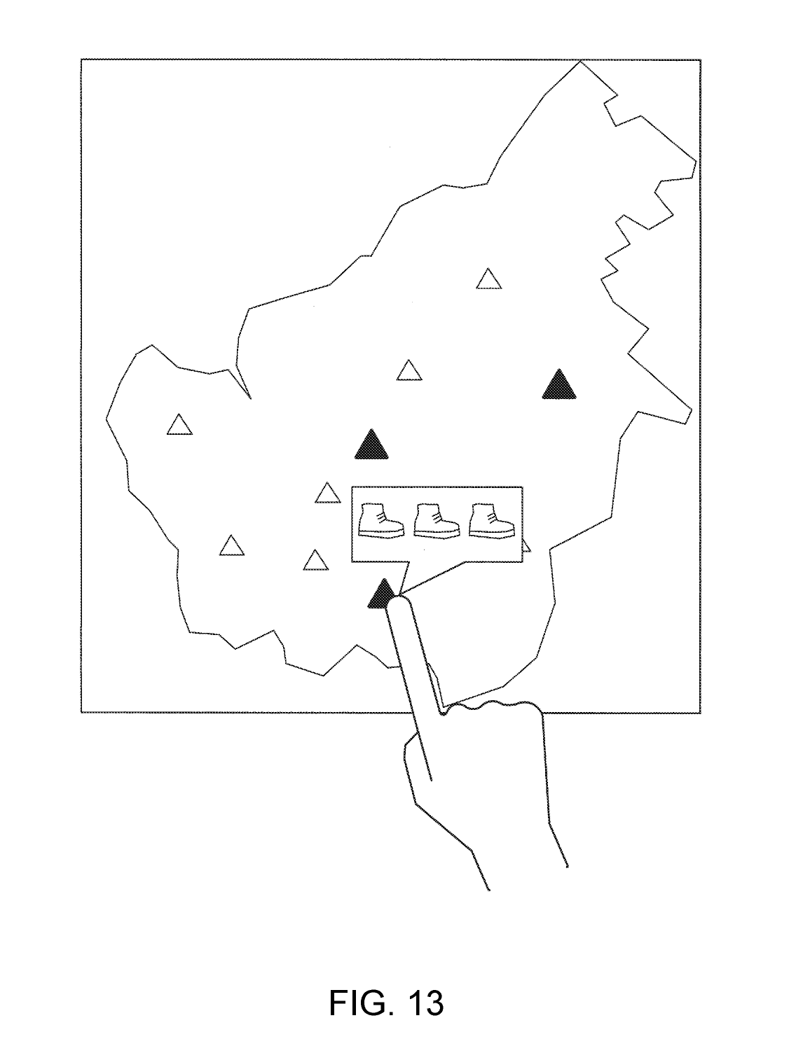

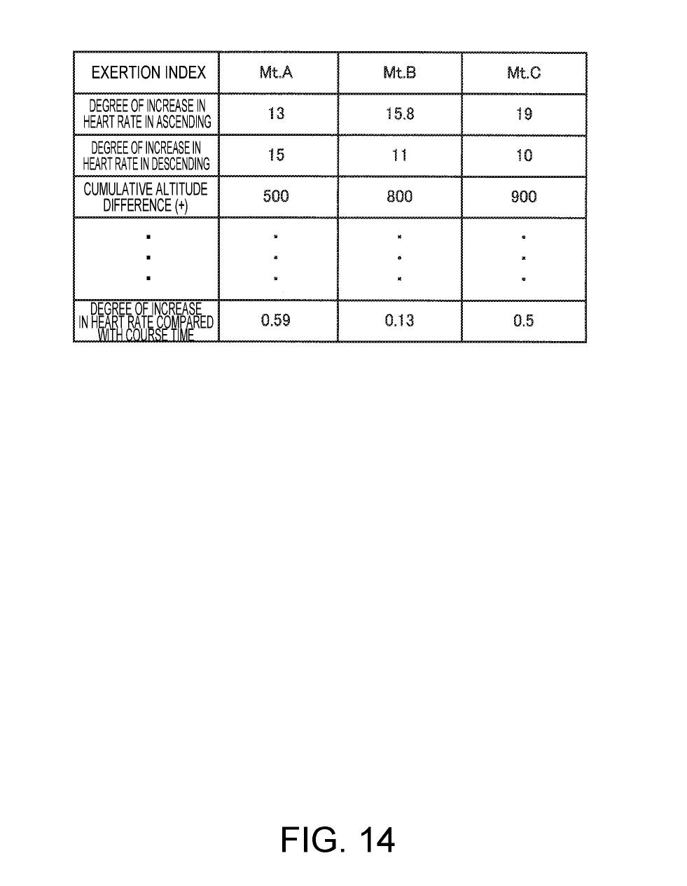

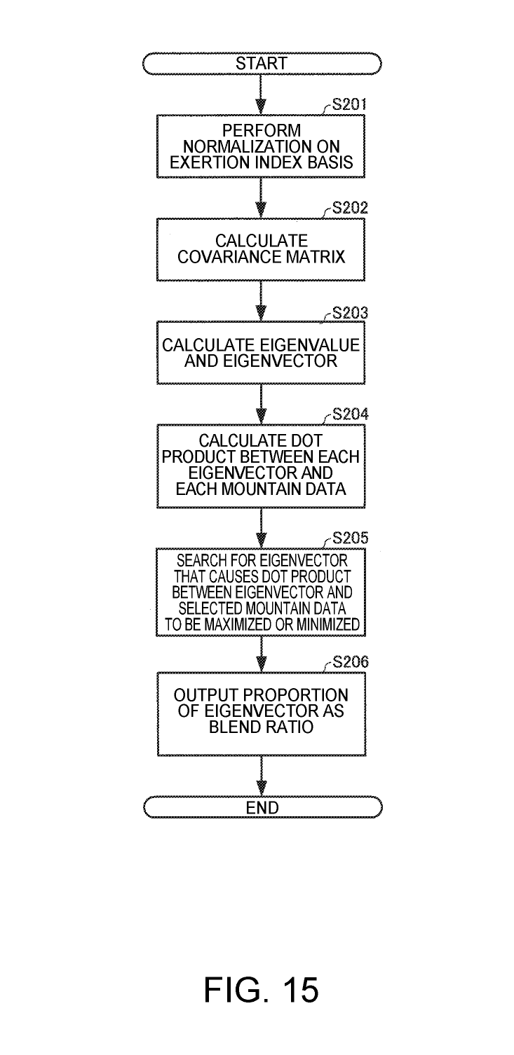

The processing section 41 of the main server 4 first calculates indices for data on each of all mountain climbing routes (in this case, data on three mountain climbing routes on three mountains). For example, the data include the degree of increase in the heart rate in ascending, the degree of increase in the heart rate at the horizontal speed, and the cumulative travel distance. Organizing the data allows acquisition of data shown in FIG. 14. The processing section 41 of the main server 4 then performs, for example, principal component analysis on the acquired data. The procedure in this case is shown in FIG. 15. The procedure in FIG. 15 will be described below. In the description, the four indices shown in the table of FIG. 14 are used.

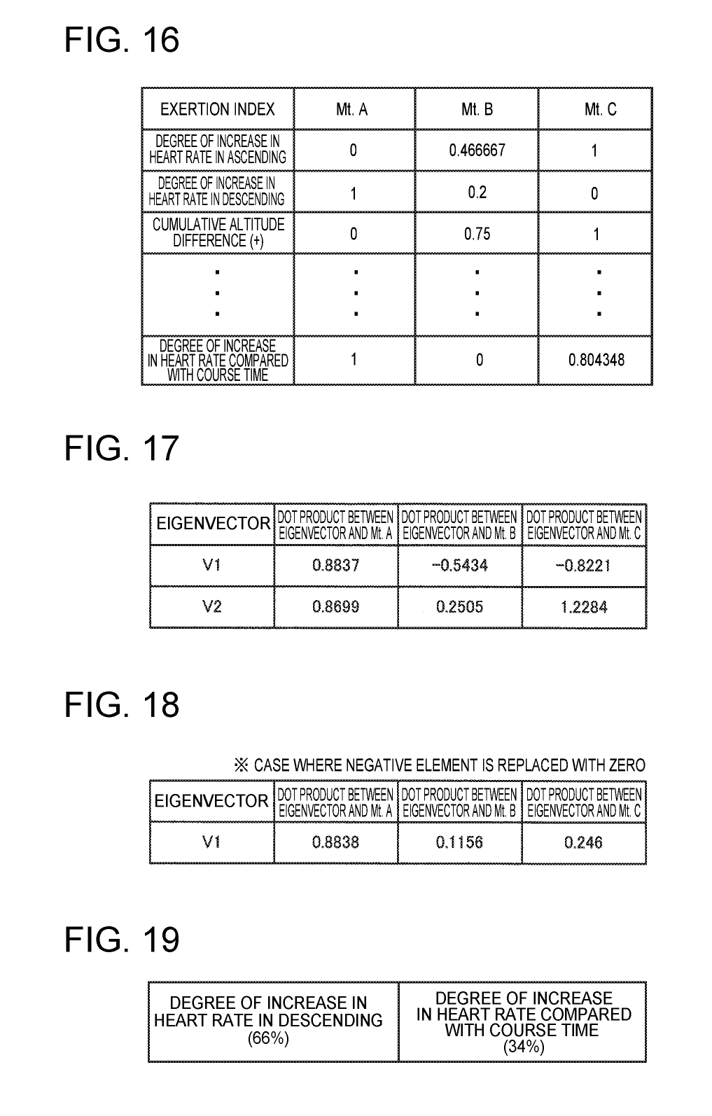

The processing section 41 first normalizes the indices (S201). The normalization is pre-processing for equally handling changes in the indices with the aid of scale conversion. FIG. 16 shows an example of the normalized indices.

The processing section 41 then determines a covariance matrix from the normalized indices. Specifically, the processing section 41 determines the covariance matrix of the following matrix (S202).

$$( \begin{matrix}0 & 1 & 0 & 1 \\ 0.4667 & 0.2 & 0.75 & 0 \\ 1 & 0 & 1 & 0.8043\end{matrix} )$$

The processing section 41 then determines the eigenvalue and the eigenvector of the matrix (S203). The eigenvalues and the eigenvectors are as follows:

$${λ}_{1} = 0.83 , {λ}_{2} = 0.24 , {λ}_{3} = 0 , {λ}_{4} = 0$$

$${v}_{1} = ( \begin{matrix}- 0.5017 \\ 0.5779 \\ - 0.5664 \\ 0.3059\end{matrix} ) , {v}_{2} = ( \begin{matrix}0.4024 \\ - 0.0398 \\ 0.0942 \\ 0.9097\end{matrix} ) , {v}_{3} = ( \begin{matrix}0.1364 \\ 0.7704 \\ 0.6162 \\ - 0.0904\end{matrix} ) , {v}_{4} = ( \begin{matrix}- 0.7535 \\ - 0.2665 \\ 0.5390 \\ 0.2658\end{matrix} )$$

The processing section 41 then calculates the dot product of the eigenvectors and mountain climbing routes Mt. A, Mt. B, and Mt. C (S204). FIG. 17 shows results of the calculation. It is, however, noted that the eigenvectors V3 and V4 each have an eigenvalue of zero, which means that eigenvectors V3 and V4 each provide no significant information, and no dot products for the eigenvectors V3 and V4 are therefore shown. For example, in a case where a blend that causes the rank of the mountain climbing route Mt. A to be “1” is searched for, the dot product between the eigenvector V1 and the mountain climbing route Mt. A is maximized, and the blend relating to the eigenvector V1 may therefore be considered to be a blend that causes the rank of the mountain climbing route Mt. A to be “1” (S205).

The degree of increase in the heart rate in ascending: −0.5

The degree of increase in the heart rate in descending: +0.58

The cumulative altitude difference (+): −0.56

The degree of increase in the heart rate compared with a course time: +0.3

The proportion of each of the values described above is subject to different interpretations, but the sign of the value has a very important meaning. The greater the number of positive (+) elements, the greater the exertion, whereas the greater the number of negative (−) elements, the smaller the exertion. Therefore, when the user travels at a higher speed along a downhill, or when the user travels in a period shorter than the course time, the resultant blend shows greater exertion. Further, when the user travels at a lower speed along an uphill, or when the cumulative altitude difference (+) is smaller, the resultant blend shows lower exertion. In general, since a negative portion is unlikely to be accepted, only positive portions may be employed and displayed as the exertion indices. FIG. 18 shows a blend having undergone the process described above (process of ignoring negative portions). Carrying out the process (process of ignoring negative portions) may not cause the rank of the mountain climbing route Mt. A to be maximized in some cases. It is, however, believed that the user does not feel that something is wrong because the statistical operation achieves the highest possible rank. Therefore, the process described above may be carried out so that the user is provided with a blend that is easy to understand as a high priority (S206) . In this case, the proportions may be displayed together as long as the signs are the same, for example, as follows.

FIG. 19 shows an example of a blend presented to the user. The presentation to the user is performed by causing the display section 25 of the information terminal 2 to display an image. The processing section 41 of the main server 4 may then save the content of the blend displayed on the screen. For example, when the user taps a save button that is not shown, the information terminal 2 transmits the content displayed on the screen (content of blend) at the time of the tapping to the main server 4 over the network 3. The main server 4 writes the content of the blend in the form of a file on the memory section 44. The information terminal 2 may instead prompt the user to specify the file name of the file (name of blend) and transmit the file name along with the content of the blend to the main server 4. The processing section 41 of the main server 4 saves the content of the blend with the file name attached thereto in the memory section 44. The blend created by the user has thus been registered.

### 1-8-9. Registration of Data in a Case Where Mountain Climbing Has Not Been Performed

There is a case where the user attempted to perform mountain climbing on the basis of a mountain climbing plan registered in advance but the mountain climbing could not be performed at all due to bad weather or an accident.

Even in this case, the fact that the user had created the plan although the plan has not been put into action may be allowed to be registered as data on the mountain climbing route in the database because the fact can be effectively used later. To this end, for example, the system (specifically, application program) may have the following function.

(1) Function of prompting the user to create a mountain climbing plan data file (including data on mountain climbing route) and registering the mountain climbing plan data file in the database. At this point, the mountain climbing plan data file may not be registered in the database but may simply be stored in the memory section 44.

(2) Function of asking the user whether or not the mountain climbing plan data is saved as data that has not been punt into action in the database after a fixed period elapses.

(3) Function of prompting the user to select (input) a reason why the data has not been put into action.

(4) Function of writing the reason inputted by the user along with the data that has not been put into action in the database.

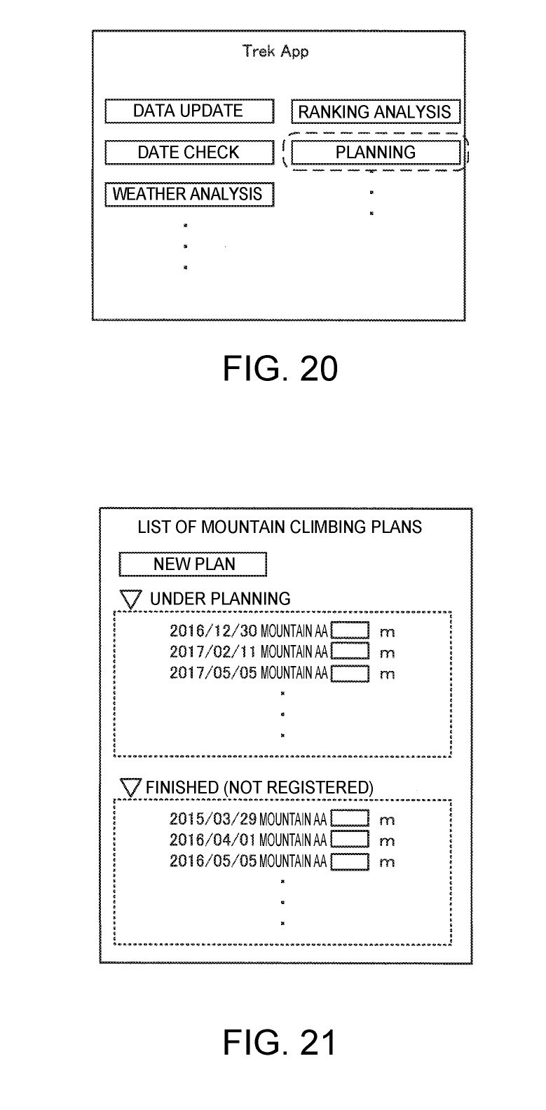

A specific description will be made below. When the user taps the “planning button” in the initial display screen (referred, for example, to as home screen and top screen), as shown in FIG. 20, a mountain climbing plan list is displayed on the screen, as shown in FIG. 21. On the screen shown in FIG. 21 are arranged a new plan button (upper side in plane of view of FIG. 21), a list of mountain climbing plans each of which has an action date and time that has not been reached (center of FIG. 21), and a list of mountain climbing plans each of which has an action date and time since which a predetermined period has elapsed but each of which has not undergone an end process (lower side in plane of view of FIG. 21).

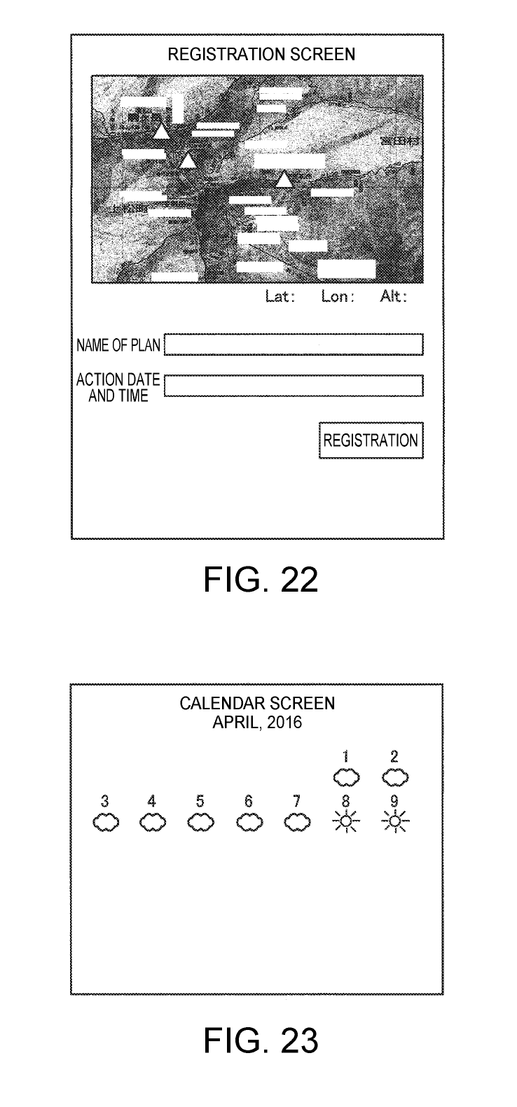

When the user taps the new plan button on the screen shown in FIG. 21, the display section 25 displays a registration screen shown in FIG. 22. On the registration screen in FIG. 22 are arranged a map, a box into which the name of a mountain climbing plan is inputted, a box into which the action date and time is inputted, and a registration button.

The user taps a point on the map to select a mountain climbing route. The selection of a mountain climbing route is performed, for example, by tapping the peak of a mountain present on the mountain climbing route or tapping any point on the mountain climbing route.

When the user taps the box into which the data and time is inputted, a calendar of a future period including the current point of time (FIG. 23) is displayed. The processing section 41 of the main server 4 causes the display section 25 of the information terminal 2 to display the calendar in accordance with a known method, and no description of the method will therefore be made.

In this process, the processing section 41 of the main server 4 may cause the display section 25 to display a weather forecast (such as weather, chance of precipitation, air temperature) in an area that belongs to the selected mountain climbing route, as shown in FIG. 23. The main server 4 can, for example, access the weather server 5 via the network 3 and obtain information on the weather in a necessary area.

Further, the processing section 41 of the main server 4 may identify the name or address (such as prefecture, city, town, and village) of a representative mountain around the point selected by the user on the map and cause the name or address to be displayed as a default value of the name of the mountain climbing plan in the box shown in FIG. 22 (box into which name of plane is inputted) . The user may register the default value as it is as the name of the plan or edit the default value to a desired name and then register the edited name as the name of the plan.

The processing section 41 of the main server 4 refers to the database on a regular basis or as required and evaluates whether or not, among the mountain climbing plan data sets each having an action date and time since which at least a predetermined period has elapsed, mountain climbing plan data that has not undergone the end process is present in the database. In a case where a result of the evaluation shows that such data is present, the processing section 41 adds the name or any factor of the mountain climbing plan to the mountain climbing plan list on the screen shown in FIG. 21 (lower side in plane of view of FIG. 21).

After the user performs mountain climbing along a mountain climbing route and uploads measured data relating to the mountain climbing route, the processing section 41 of the main server 4 evaluates whether or not the database contains mountain climbing plan data having the same time schedule and mountain climbing route as those of the updated mountain climbing plan data. In a case where a result of the valuation shows that the database contains such data, the processing section 41 automatically or after the user's confirmation causes the mountain climbing plan data to undergo the end process. The end process includes writing measured data on the mountain climbing plan data file, setting an end flag, and other types of operation.

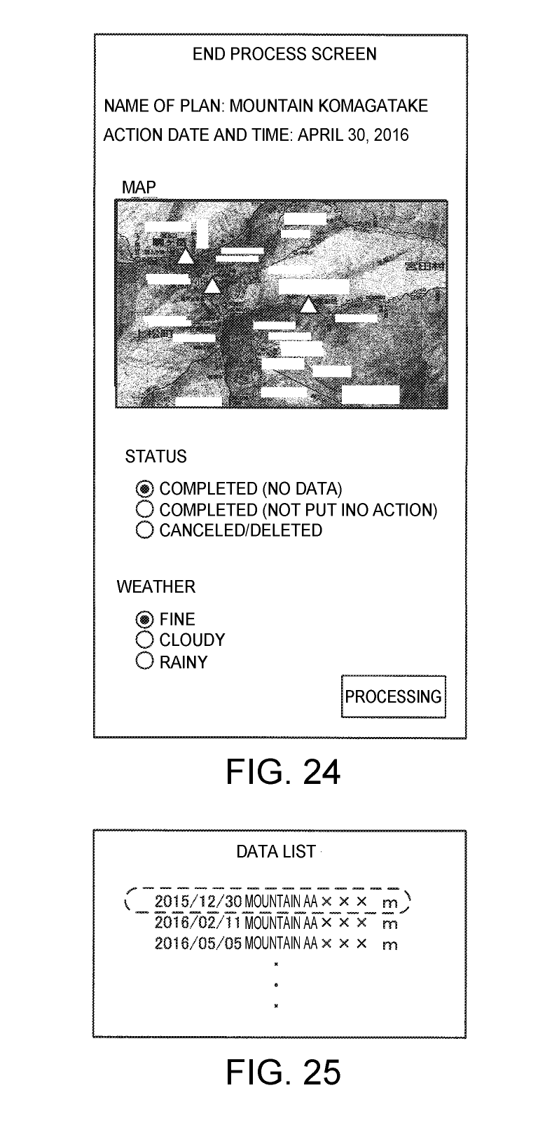

The mountain climbing plan list disposed on the lower side of FIG. 21 in the plane of view thereof lists mountain climbing plan data sets that have not undergone the end process (mountain climbing plan data sets with no end flag set). The user may be allowed to select and tap any one of the mountain climbing plans from those in the list to cause the mountain climbing plan to undergo the end process, for example, via the screen shown in FIG. 24.

On the screen shown in FIG. 24 are displayed the name of the mountain climbing plan, the action data and time when the mountain climbing plan is put into action, a map including the mountain climbing route, and the like. It is, however, noted that the user is not allowed to edit the name of the plan, the action date/time, the map, and other pieces of information.

Radio buttons for specifying the status of the mountain climbing plan and radio buttons for setting the weather are arranged in a lower portion of FIG. 24 in the plane of view thereof.

The user can operate any of the radio buttons for setting the status to set the status of the mountain climbing plan. The mountain climbing plan data are handled differently in accordance with the status of the mountain climbing plan.

For example, in a case where the user performed mountain climbing in accordance with the mountain climbing plan but no measured data was updated because the user did not carry the electronic apparatus 1, the battery of the electronic apparatus 1 went out, or any other accident occurred, the user sets the status of the mountain climbing plan to be “completed (no data). ” In this case, the mountain climbing plan data in the database undergoes the end process. The end process includes the process of imparting information representing the status to the mountain climbing plan data file.

Further, in a case where the user could not perform mountain climbing in accordance with the mountain climbing plan due to the weather, the user's physical condition, an essential thing that the user forgot to bring, or any other accident, the user sets the status of the mountain climbing plan to be “completed (not put into action).” In this case, the mountain climbing plan data in the database undergoes the end process. The end process includes the process of imparting information representing the status to the mountain climbing plan data file.

In a case where the mountain climbing is abandoned in the middle thereof and other similar cases, the user sets the status of the mountain climbing plan to be “canceled/deleted.” In this case, the mountain climbing plan data is completely deleted from the database.

In a case where the user sets the status of the mountain climbing plan to be “completed (no data) or “completed (not put into action),” the user operates any of the radio buttons for setting the weather to input the weather. Although not shown in FIG. 24, an “automation button” may be disposed on the screen. When the user taps the automation button, the weather record corresponding to the action date/time and the mountain climbing route is referred to, and the weather is automatically inputted.

The processing section 21 of the information terminal 2 transmits the fact that the user has tapped the automation button to the main server 4 over the network 3. The processing section 41 of the main server 4, when it receives the fact, refers to the mountain climbing route and the action date and time contained in the mountain climbing plan and captures, among the records on the weather in the area to which the mountain climbing route belongs, a weather record corresponding to the action date and time from the weather server 5 over the network 3. The processing section 41 of the main server 4 evaluates whether or not the weather in the mountain climbing route and on the action date and time was “fine,” “cloudy,” or “rainy” and transmits a result of the evaluation to the information terminal 2 over the network 3. The information terminal 2 reflects the received result in the radio buttons (radio buttons for setting weather).

### 1-8-10. Registration of Friends

The processing section 41 of the main server 4 may write a traveling companion with whom the user has performed the mountain climbing on the mountain climbing route data. FIGS. 25, 26, and 27 show examples of screens for registering a traveling companion. A person who is allowed to be specified as a traveling companion by the user may be another user who has received information from the main server 4 (that is, user registered in main server 4) , as the user has, or even a person who has not received the information. The users registered in the main server 4 can receive SNS (social networking service) (share information, for example) via the main server 4.

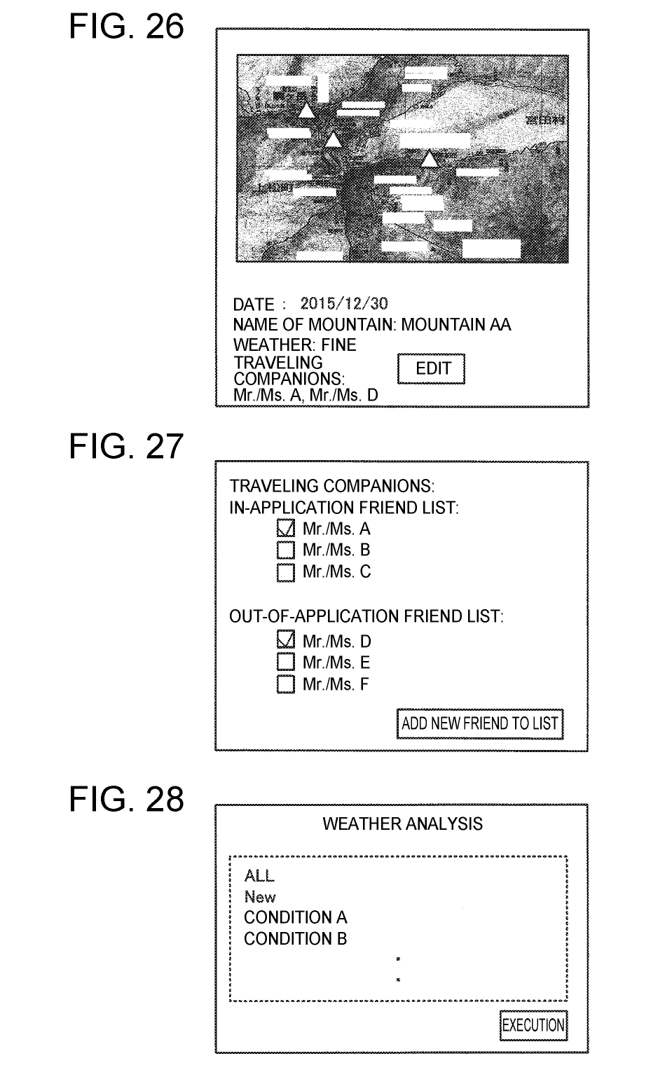

The processing section 41 of the main server 4 first causes the display section 25 of the information terminal 2 to display a mountain climbing route data list, as shown in FIG. 25. When the user taps any of the mountain climbing routes on the screen shown in FIG. 25, information on the mountain climbing route is displayed, as shown in FIG. 26. On the screen shown in FIG. 26 are displayed traveling companions “Mr./Ms. A” and “Mr./Ms. D” registered in relation to the mountain climbing route. An edit button for editing the traveling companions is disposed on the edit screen shown in FIG. 26. When the user taps the edit button, the display section 25 displays an edit screen shown in FIG. 27.

An in-application friend list with checkboxes and an out-of-application friend list with checkboxes are arranged on the edit screen. The in-application friend list lists one or more users who not only are the users registered in the main server 4 but have been registered in advance as friends by the user of the electronic apparatus 1. The user can mark the checkbox corresponding to a desired user to specify the user as a traveling companion. On the other hand, the out-of-application friend list lists one or more persons who not only are persons other than the users registered in the main server 4 but have been registered as friends in advance by the user of the electronic apparatus 1. The user can mark the checkbox corresponding to a desired user to specify the user as a traveling companion.

A button for adding a new friend to the list is disposed on the screen shown in FIG. 27. When the user taps the newly adding button, the display section 25 displays a new registration screen (not shown). The user can register a new friend and other arbitrary pieces of information (such as gender and age) on the new registration screen.

The screen shown in FIG. 26 maybe so configured that information other than traveling companions can be inputted as required. The screen shown in FIG. 26 may also be so configured that when the user taps an item on the screen, an edit screen is displayed and the item can be edited.

The weather information on the screen shown in FIG. 26 can also be edited. In the example shown in FIG. 26, “Fine” has been inputted. As for the weather information, the screen shown in FIG. 26 maybe provided with the function of capturing from the weather server 5 the weather in the region to which the mountain belongs and in the time frame for which the mountain climbing is performed and automatically inputting the weather.

In particular, immediately after data on a mountain climbing route is uploaded from the electronic apparatus 1 to the information terminal 2, the automatic input function of setting initial values enhances the user's convenience.

The reason for this is that the user only needs in practice to edit the default weather only in a case where the default weather differs from the weather that the user desires to input. In this case, in a case where the mountain climbing period is long (such as longer than or equal to one day) , the weather on the first day may be simply set as the default.

The main server 4 may have the function of calculating the chance of precipitation on a user basis by using the registration information described above, comparing the chances with one another, and displaying a result of the comparison. A specific example of a screen provided by the application program will be shown below.

When the user taps the weather analysis button (FIG. 5) disposed in the application initial screen (home screen or top screen), a restriction condition selection screen is displayed (FIG. 28).

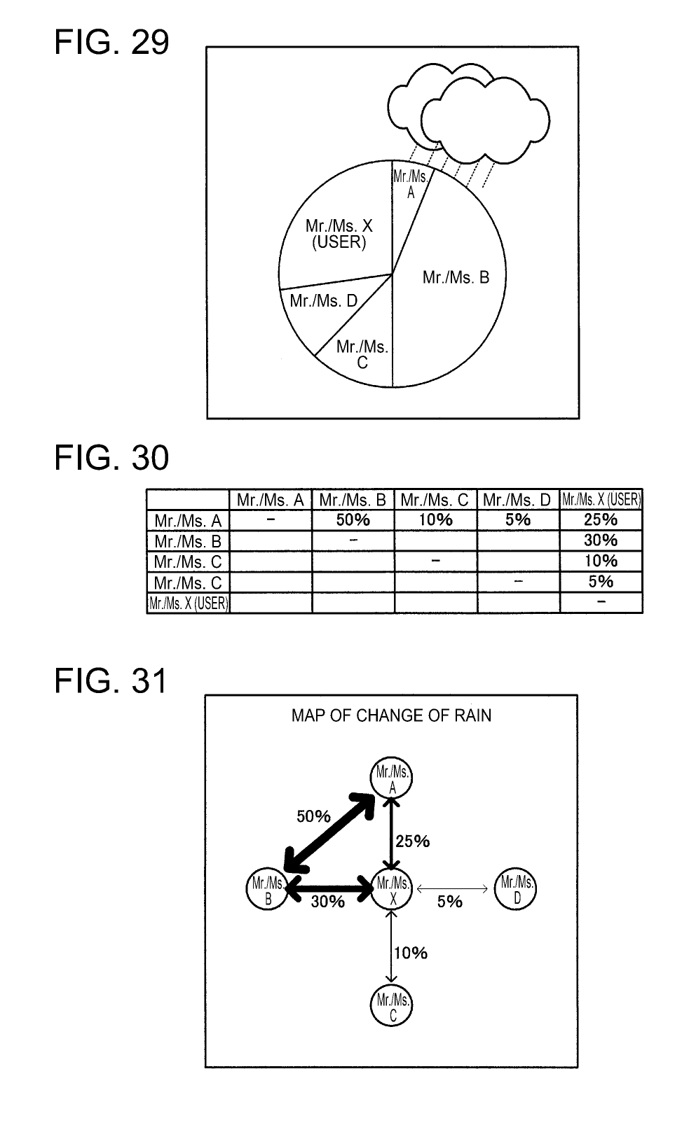

The restriction condition is the same as the restriction condition described above. When the user selects any of the restriction conditions and taps an execution button, a pie chart showing the chance of precipitation on an individual basis (FIG. 29) is displayed.

In the example shown in FIG. 29, Mr./Ms. A has a chance of encountering rain of 5% (rainy once every 20 times) , Mr./Ms. B has a chance of encountering rain of 50%, Mr./Ms. C has a chance of encountering rain of 10%, Mr./Ms. D has a chance of encountering rain of 15%, and Mr./Ms. X (user) has a chance of encountering rain of 30%. FIG. 29 shows that Mr./Ms. B has a particularly high chance of encountering rain, and that Mr./Ms. X (user) also has a high chance of encountering rain. On the other hand, the data shown in the pie chart indicates that Mr./Ms. A has a very high chance of relishing fine weather.

Further, the main server 4 may have the function of calculating and displaying the weather (chance of rain) for each combination of persons that form a mountain climbing party. For example, consider a case where two of the persons that form a mountain climbing party form a pair, and calculate chances of rain for each combination in a round-robin fashion over a certain number of persons. Specifically, consider a case where results of the calculation are those shown in FIG. 30. In this case, for example, by looking at only particularly high chances, chances higher than 25% may be picked up and displayed in the form of a map (person correlation diagram) , such as that show in FIG. 31.

In the example shown in FIG. 31, the magnitude of the chance of rain is expressed in the form of the thickness of the arrow. That is, a combination of persons connected to each other with a thick arrow shows that a high chance of precipitation. The displayed persons in FIG. 31 (circular marks) may each be replaced with a photo registered, for example, in SNS.

The process of calculating the chance of rain described above is carried out with higher accuracy in consideration of data on a mountain climbing plan that has not been put into action due to rain. The weather information (radio button to be set) described in the paragraph “Registration of data in a case where mountain climbing has not been performed” can therefore be used to improve the accuracy of the chance of rain with the burden on the users minimized, whereby the calculated chance of rain can be close to the sensation of the users.

### 1-9. Advantageous Effects of Embodiment

According to the system of the embodiment described above, the following effects are expected.

(1) Since ranking based on the user's original blend can be provided, the user can feel an attachment to a result of the ranking.

(2) Since the user can look back the user's mountain climbing history in the form of the ranking, the user is likely to feel pleasure, a sense of accomplishment, and other types of feeling as compared with a case where the user looks back the user's mountain climbing history alone.

(3) Since the ranking itself is performed on the basis of a objective reference although the user's original blend is used, a result of the ranking is sufficiently persuasive. Further, use of the objective reference is effective in conveying a result of the ranking from the user to another person.

### 2. Variations

### 2-1. Use of Another User's Database

In the embodiment described above, the range of a mountain climbing route to be ranked is limited to the range of the user's own database. The range of a mountain climbing route may instead be extended to the ranges of a variety of users' databases.

Since a user who has registered only a small number of mountain climbing routes in the user's database initially receive a small amount of pleasure resulting from the ranking, the main server 4 may perform ranking, for example, using another user's database or the average of data on a large number of users (ranking based on data interpolation).

Depending on the specifications of the electronic apparatus 1 possessed by the user, a case where all measured data cannot be collected is conceivable. In this case, part of the indices cannot be calculated in some cases. To avoid the problem, the main server 4 may use another user's database to perform the ranking relating to the user (ranking based on data interpolation).

2-2. Continuation of Data

The aforementioned embodiment has been described with reference to the case where one user uses only one electronic apparatus 1. One user may instead use a plurality of electronic apparatus 1. In this case, the main server 4 may manage the plurality of electronic apparatus 1 with one person related thereto. The management mechanism described above is convenient, for example, because the user can continuously use the database in a case where the user purchases a new electronic apparatus 1 and replaces the existing electronic apparatus 1 with the new electronic apparatus 1.

### 3. Other Variations

The invention is not limited to the embodiment described above, and a variety of variations are conceivable to the extent that they fall within the scope of the substance of the invention.

For example, in the embodiment described above, part or entirety of the functions of the main server 4 may be incorporated in the information terminal 2 or the electronic apparatus 1, part of the functions of the information terminal 2 and the electronic apparatus 1 may be incorporated in the main server 4, part or entirety of the functions of the electronic apparatus 1 may be incorporated in the information terminal 2, or part or entirety of the functions of the information terminal 2 may be incorporated in the electronic apparatus 1.

Further, the electronic apparatus 1 or the information terminal 2 may be provided with known functions of a smartphone, for example, a camera function, a call function, and a communication function.

The electronic apparatus 1 or the information terminal 2 may be further provided with another sensing function (such as humidity sensor) of sensing at least part of the user's sport activity (including biological activity).

The electronic apparatus 1 or the information terminal 2 can be configured as a wrist-type electronic apparatus, an earphone-type electronic apparatus, a finger-ring-type electronic apparatus, a pendant-type electronic apparatus, an electronic apparatus attached to a sport gear for use, a smartphone, a head mounted display (HMD), and mobile information apparatus of a variety of other types.

The electronic apparatus 1 or the information terminal 2 may notify the user of information in the form of image display, sound output, vibration, or any other type of action or a combination of at least two of the image display, sound output, and vibration.

In the embodiment described above, a GPS (Global Positioning System) is used as a satellite positioning system, and any other global navigation satellite system (GNSS) may instead be used. For example, one of or two or more of EGNOS (European Geostationary-Satellite Navigation Overlay Service), QZSS (Quasi Zenith Satellite System), GLONASS (GLObal NAvigation Satellite System), GALILEO, BeiDou (BeiDou Navigation Satellite System), and other satellite positioning systems may be used. Further, WAAS (Wide Area Augmentation System) or any other satellite-based augmentation system (SBAS) maybe used as at least one of the satellite positioning systems.

The embodiment and the variations described above are presented by way of example, and the invention is not limited thereto. For example, the embodiment and any of the variations can be combined with each other as appropriate.

The invention encompasses substantially the same configuration as the configuration described in the embodiment (for example, a configuration having the same function, using the same method, and providing the same result or a configuration having the same purpose and providing the same effect). Further, the invention encompasses a configuration in which an inessential portion of the configuration described in the embodiment is replaced. Moreover, the invention encompasses a configuration that provides the same advantageous effects as those provided by the configuration described in the embodiment or a configuration that can achieve the same purpose as that achieved by the configuration described in the embodiment. Further, the invention encompasses a configuration in which a known technology is added to the configuration described in the embodiment.

What is claimed is:

1. A ranking system comprising at least one computing device including:
a selection section that receives a user selection and selects a reference for ranking a plurality of routes based at least in part on the received user selection, wherein the reference is at least one characteristic associated with each route of the plurality of routes;
a memory section that stores data on each route of the plurality of routes;
a ranking section that retrieves the data on each route of the plurality of routes from the memory section and ranks the plurality of routes based on the selected reference and the retrieved data on each route of the plurality of routes; and
an output section that outputs a result of the ranking.

2. The ranking system according to claim 1,
wherein the reference comprises a plurality of different references, and
the ranking section ranks the plurality of routes by weighting the plurality of references.

3. The ranking system according to claim 2,
wherein the weighting is specified by a user.

4. The ranking system according to claim 1,
wherein the output section outputs the result of the ranking to present the plurality of routes in a descending rank order.

5. The ranking system according to claim 1,
wherein the output section outputs the result of the ranking by displaying the plurality of routes on a display section along with a rank of each route of the plurality of routes on a map.

6. A server comprising:
a selection section that receives a user selection and selects a reference for ranking a plurality of routes based at least in part on the received user selection, wherein the reference is at least one characteristic associated with each route of the plurality of routes;
a memory section that stores data on each route of the plurality of routes;
a ranking section that retrieves the data on each route of the plurality of routes from the memory section and ranks the plurality of routes based on the selected reference and the retrieved data on each route of the plurality of routes; and
an output section that outputs a result of the ranking of the plurality of routes.

7. A ranking method performed by a computing device, the method comprising:
receiving a user selection;
selecting a reference for ranking a plurality of routes based at least in part on the user selection, wherein the reference is at least one characteristic associated with each route of the plurality of routes;
retrieving data on each route of the plurality of routes from a memory section;
ranking the plurality of routes based on the selected reference and the retrieved data on each route of the plurality of routes; and
outputting a result of the ranking of the plurality of routes.

8. The ranking method according to claim 7,
wherein the reference comprises a plurality of different references, wherein each reference of the plurality of different references is at least one characteristic associated with each route of the plurality of route, and
ranking the plurality of routes comprises weighting the plurality of references.

9. The ranking method according to claim 8,
wherein the weighting is specified by a user.

10. The ranking method according to claim 7,
wherein outputting the result of the ranking of the plurality of routes comprises presenting the plurality of routes in a descending rank order.

11. The ranking method according to claim 7,
wherein outputting the result of the ranking of the plurality of routes comprises displaying the plurality of routes on a display device, along with a rank of each route of the plurality of routes on a map.

12. A non-transitory computer readable medium that stores instructions that, when executed by a processor, cause the processor to perform a method comprising:
receiving a user selection;
selecting a reference for ranking a plurality of routes based at least in part on the user selection, wherein the reference is at least one characteristic associated with each route of the plurality of routes;
retrieving data on each route of the plurality of routes from a memory section;
ranking the plurality of routes based on the selected reference and the retrieved data on each route of the plurality of routes; and
outputting a result of the ranking of the plurality of routes.

13. An electronic apparatus that
receives a user selection;
selects a reference for ranking a plurality of routes based at least in part on the user selection, wherein the reference is at least one characteristic associated with each route of the plurality of routes;
retrieves data on each route of the plurality of routes from a memory section;
ranks the plurality of routes based on the selected reference and the retrieved data on each route of the plurality of routes; and
outputs a result of the ranking of the plurality of routes.

14. The electronic apparatus according to claim 13,
wherein the reference comprises a plurality of different references, and
the apparatus ranks the plurality of routes by weighting the plurality of references.

15. The electronic apparatus according to claim 14,
wherein the weighting is specified by a user.

16. The electronic apparatus according to claim 13,
wherein the apparatus outputs the result of the ranking to present the plurality of routes in a descending rank order.

17. The electronic apparatus according to claim 13,
wherein the outputs the result of the ranking by displaying the plurality of ranked routes on a display section along with a rank of each route of the plurality of routes on a map.

18. A non-transitory computer readable medium that stores instructions that, when executed by a processor, cause the processor to perform a method comprising:
receiving a plurality of routes created by a user, each route corresponding to a route between a starting location and an ending location of a different geographic location;
receiving, for each route of the plurality of routes, measured data collected during performance by the user of said route;
storing the plurality of routes and the measured data in a memory section as plan data files;
receiving a user selection for ranking the plurality of routes;
selecting, based at least in part on the user selection for ranking the plurality of routes, at least one reference for ranking the plurality of routes, the at least one reference comprising at least one of an index and a restricting condition
retrieving the plan data files;
ranking the plurality of routes based on the received selection of at least one reference and the retrieved plan data files; and
outputting a result of the ranking of the plurality of routes.

19. The non-transitory computer readable medium of claim 18, wherein the at least one reference comprises at least one restricting condition, and retrieving the plan data files comprises retrieving the plan data files that meet the at least one restricting condition.

20. The non-transitory computer readable medium of claim 18, wherein:
the at least one reference comprises a plurality of indices;
the method further comprises determining a weighting of the plurality of indices; and
ranking the plurality of routes based on the received selection of at least one reference and the retrieved plan data files includes ranking the plurality of routes based on the weighting of the plurality of indices.

21. The non-transitory computer readable medium of claim 20, wherein:
the method further comprises receiving a user weighting of the plurality of indices; and
determining the weighting of the plurality of indices comprises determining the weighting of the plurality of indices based on the user weighting of the plurality of indices.

22. The non-transitory computer readable medium of claim 18, wherein outputting the result of the ranking of the plurality of routes comprises presenting the plurality of routes in a descending rank order.

23. The non-transitory computer readable medium of claim 18, wherein the user selection for ranking the plurality of routes includes the at least one reference for ranking the plurality of routes.

24. The non-transitory computer readable medium of claim 18, wherein:
the user selection for ranking the plurality of routes comprises a selected route of the plurality of routes; and
selecting at least one reference for ranking the plurality of routes ranking the plurality of routes comprises selecting at least one reference that maximize a ranking of the selected route among the plurality of routes.

25. The non-transitory computer readable medium of claim 24, wherein selecting at least one reference that maximize a ranking of the selected route among the plurality of routes comprises:
calculating a plurality of indices for each route of the plurality of routes; and
analyzing the plurality of indices for each route to determine at least one preference that will maximize a ranking of the selected route among the plurality of routes.

26. The non-transitory computer readable medium of claim 24, wherein analyzing the plurality of indices for each route to determine at least one preference that will maximize a ranking of the selected route among the plurality of routes comprises preforming principal component analysis on the plurality of indices for each route.

27. A system for ranking a plurality of routes comprising:
an electronic apparatus including a plurality of sensors that measure data associated with the user during performance of the plurality of routes;
an information terminal communicatively coupled to the electronic apparatus, the information terminal including instructions that cause the information terminal to:
receive selections from the user to create a plurality of plan data files, each plan data file corresponding to a different route of the plurality of routes, each route corresponding to a route between a starting location and an ending location of a different geographic location;
receive the measured data associated with the user performance during performance of the plurality of routes;
receive a user selection for ranking the plurality of routes; and
output the user selection for ranking the plurality of routes, the measured data for each route of the plurality of routes, and the plurality of plan data files;
a server communicatively coupled to the information terminal, the server including a processor and a memory section, the memory section that stores instructions that, when executed by the processor, cause the server to:
receive, from the information terminal, the user selection for ranking the plurality of routes, and the measured data and plan data file for each route of the plurality of routes;
select, based at least in part on the user selection for ranking the plurality of routes, at least one reference for ranking the plurality of routes, the at least one reference comprising at least one of an index and a restricting condition
rank the plurality of routes based on the received selection of at least one reference and the plan data files; and
output a result of the ranking of the plurality of routes to the information terminal.

28. The system of claim 27 wherein the electronic apparatus comprises a human wearable electronic apparatus.

29. The system of claim 27, wherein the information terminal further comprises a display section, and the information terminal includes instructions that cause the information terminal to:
receive the result of the ranking of the plurality of routes from the server; and
display the result of the ranking of the plurality of routes from the server on the display section.
